(19) United States
(12) Patent Application Publication
(10) Pub. No.: US 2008/0293676 A1
(43) Pub. Date: Nov. 27, 2008

(54) Insecticidal Agents Based on Selected Insecticides and Safeners

(75) Inventors: Reiner Fischer, Monheim (DE); Wolfram Andersch, Bergisch Gladbach (DE); Heike Hungenberg, Langenfeld (DE); Wolfgang Thielert, Odenthal (DE); Lothar Willms, Hofheim am Taunus (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: BAYER CROPSCIENCE AG, Monheim (DE)

(21) Appl. No.: 11/632,929

(22) PCT Filed: Jul. 18, 2005
(86) PCT No.: PCT/EP05/07792

§ 371 Date: Jul. 25, 2008

(30) Foreign Application Priority Data
Jul. 20, 2004 (DE) 10 2004 035 132.5

(51) Int. Cl. A01N 57/16; A01N 37/34; A01N 43/54; A01N 47/12; A01N 37/18; A01N 43/42; A01N 43/56; A01P 7/00

(52) U.S. Cl. 514/89; 514/515; 514/256; 514/479; 514/625; 514/311; 514/403

(57) ABSTRACT

Insecticidal compositions characterized by an effective amount of an active ingredient combination comprising
(a) one or more compounds selected from the group of acetylcholinesterase inhibitors, sodium channel modulators, chitin biosynthesis inhibitors, juvenile hormone mimetics, chloride channel activators, ecdysone agonists, GABA-controlled chloride channel antagonists or acaricides,
and
(b) at least one crop plant tolerance promoter compound from the group of compounds specified in the description,
   which are used for controlling arthropods, and also methods of controlling arthropods through the treatment of plants and their seed with these compositions.

The invention relates to insecticidal active ingredient combinations which comprise on the one hand one or more compounds selected from the group of acetylcholinesterase inhibitors, sodium channel modulators, chitin biosynthesis inhibitors, juvenile hormone mimetics, chloride channel activators, ecdysone agonists, GABA-controlled chloride channel antagonists and selected acaricides and on the other hand at least one crop plant tolerance promoter compound, and also to their use for controlling insects and arachnids (acarids) in various plant crops and for treating seed.

It is known that the compounds 2-(acetyloxy)-3-dodecyl-1,4-naphthalenidone, abamectin, acephate, alpha-cypermethrin, amitraz, azadirachtin, azinphosmethyl, betacyfluthrin, bifenthrin, bromopropylate, buprofezin, carbaryl, chinomethionat, chlorfenapyr, chlorfenvinphos, chlorfluazuron, chlorpyrifos, cyhalothrin, cypermethrin, cyromazin, deltamethrin, diafenthiuron, diazinon, dichlorphos, dicofol, dicrotophos, diflubenzuron, dimethoate, diofenolan, disulfoton, emamectin, endosulfan, esfenvalerate, ethion, etofenprox, fenazaquin, fenitrothion, fenoxycarb, fenpropathrin, fenpyrad (tebufenpyrad), fenthion, fenvalerate, fipronil, flucythrinate, formetanate, hexythiazox, indoxacarb, isoxathion, ivermectin, lambda-cyhalothrin, lindane (gamma-HCH), lufenuron, malathion, methamidophos, methidathion, methiocarb, methomyl, methoxyfenozide, mevinphos, milbemectin, monocrotophos, oxamyl, oxydemeton-methyl, parathion, parathion-methyl, permethrin, phenthoate, phorate, phosalone, phosmet, phosphamidon, phoxim, pirimicarb, pirimiphos-methyl, profenophos, propargite, propoxur, prothiophos, pymetrozine, pyrimidifen, pyriproxyfen, spinosad, tau-fluvalinate, tebufenozide, tebupyrimphos, teflubenzuron, tetradifon, thiocyclam, thiodicarb, thuringiensin, tralomethrin, triarathene, triazamate, triazophos, trichlorfon, trichogramma spp., triflumuron and zeta-cypermethrin and also the biologicals acrinathrin, Verticillium lecanii and Trichogramma spp. can be used for controlling insects and/or Acarina.

The activity and/or tolerance of the compounds with respect to the plants they are used to treat is not entirely satisfactory, however, at every application rate and under all conditions.

Surprisingly it has now been found that the aforementioned insecticides, when employed together with the crop plant tolerance promoter compounds (referred to as safeners or antidotes) described further on below, have an unexpectedly good activity in conjunction with unexpectedly good crop plant tolerance and can be used with particular advantage as broad-spectrum combination products for controlling insects.

The invention accordingly provides insecticidal compositions comprising
(a) an effective amount of one or more of the compounds selected from one or more of the following groups (A) to (I):
   (A) Acetylcholinesterase inhibitors

### A.1 Organophosphates

### A.1.1 Azinphos-methyl

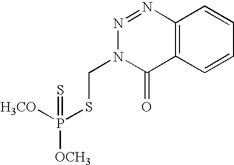

known from U.S. Pat. No. 2,758,115

### A.1.2 Chlorpyrifos

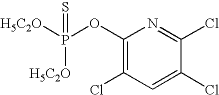

known from U.S. Pat. No. 3,244,586

### A.1.3 Diazinon

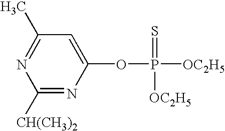

known from U.S. Pat. No. 2,754,243

### A.1.4 Dimethoate

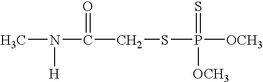

known from U.S. Pat. No. 2,494,283

### A.1.5 Disulfoton

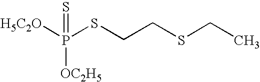

known from DE-A-917 668

### A.1.6 Ethion

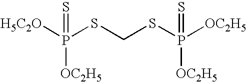

known from U.S. Pat. No. 2,873,228

### A.1.7 Fenitrothion

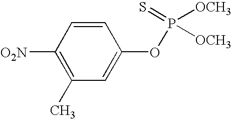

known from BE-A-594 669

### A.1.8 Fenthion

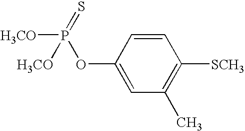

known from DE-A-1 116 656

### A.1.9 Isoxathion

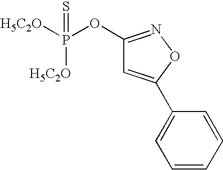

known from DE-A-1 567 137

### A.1.10 Malathion

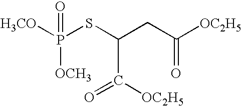

known from U.S. Pat. No. 2,578,562

### A.1.11 Methidathion

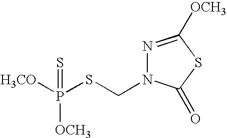

known from DE-A-1 645 982

### A.1.12 Oxydemeton-methyl

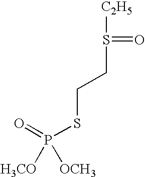

known from DE-A-947 368

### A.1.13 Parathion

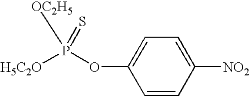

known from DE-A-814 152

### A.1.14 Parathion-methyl

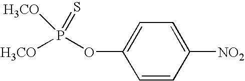

known from DE-A-814 142

### A.1.15 Phenthoate

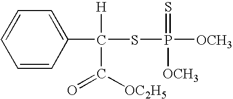

known from GB-A-834 814

### A.1.16 Phorate

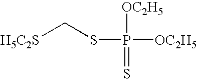

known from U.S. Pat. No. 2,586,655

### A.1.17 Phosalone

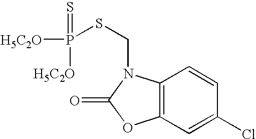

known from DE-A-2 431 192

### A.1.18 Phosmet

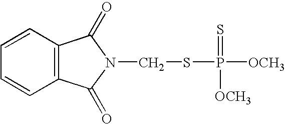

known from U.S. Pat. No. 2,767,194

### A.1.19 Phoxim

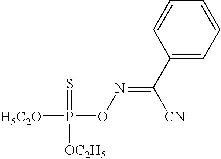

known from DE-A-1238 902

### A.1.20 Pirimiphos-methyl

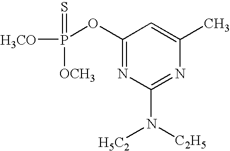

known from DE-A-1 445 949

### A.1.21 Profenofos

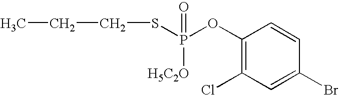

known from DE-A-2 249 462

### A.1.22 Prothiofos

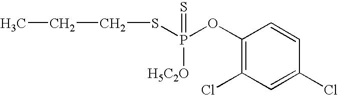

known from DE-A-2 111 414

### A.1.23 Tebupirimfos

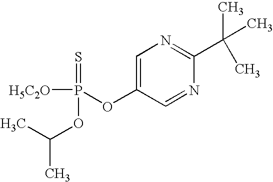

known from DE-A-3 317 824

### A.1.24 Triazophos

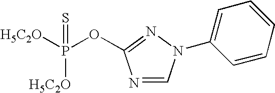

known from DE-A-1 299 924

### A.1.25 Chlorfenvinphos

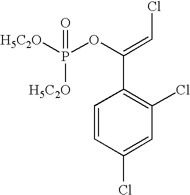

known from U.S. Pat. No. 2,956,073

### A.1.26 Dichlorphos

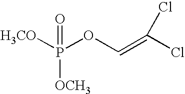

known from GB-A-775 085

### A.1.27 Dicrotophos

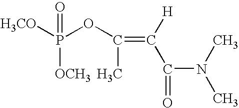

known from BE-A-55 22 84

### A.1.28 Mevinphos

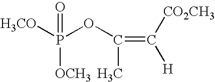

known from U.S. Pat. No. 2,685,552

### A.1.29 Monocrotophos

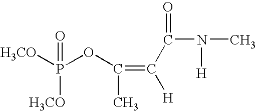

known from DE-A-1 964 535

### A.1.30 Phosphamidon

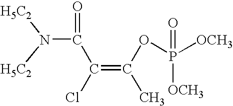

known from U.S. Pat. No. 2,908,605

### A.1.31 Acephate

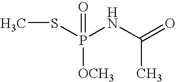

known from DE-A-2 014 027

### A.1.32 Methamidophos

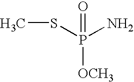

known from U.S. Pat. No. 3,309,266

### A.1.33 Trichlorfon

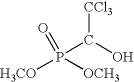

known from U.S. Pat. No. 2,701,225

### A.2 Carbamates

### A.2.1 Carbaryl.

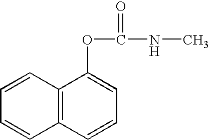

known from U.S. Pat. No. 2,903,478

### A.2.3 Formetanate

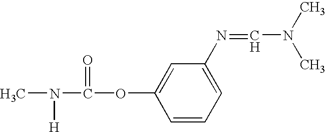

known from DE-A-1 169 194
A.2.4 Formetanate hydrochloride known from DE-A-1169 194

### A.2.5 Methiocarb

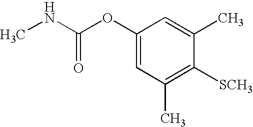

known from DE-A-1 162 352

### A.2.6 Methomyl

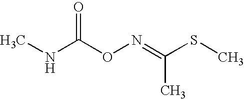

known from U.S. Pat. No. 3,639,620

### A.2.7 Oxamyl

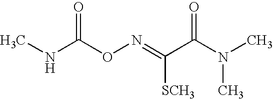

known from DE-A-1 768 623

### A.2.8 Pirimicarb

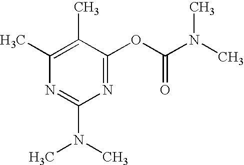

known from GB-A-1 181 657

### A.2.9 Propoxur

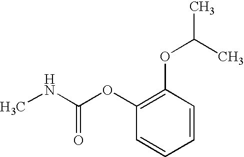

known from DE-A-1 108 202

### A.2.10 Thiodicarb

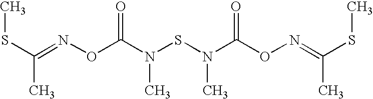

known from DE-A-2 530 439

### (B) Sodium Channel Modulators

### B.1 Pyrethroids

### B.1.1 Acrinathrin

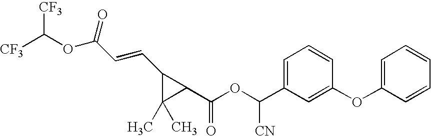

known from EP-A-048 186

### B.1.2 Alpha-Cypermethrin

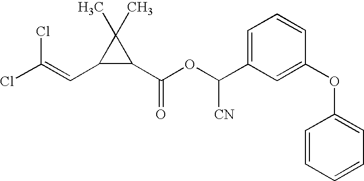

known from EP-A-067 461

### B.1.3 Beta-Cyfluthrin

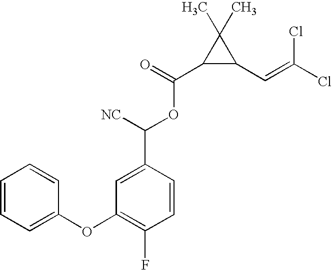

known from EP-A-206 149

B.1.4 Cyhalothrin

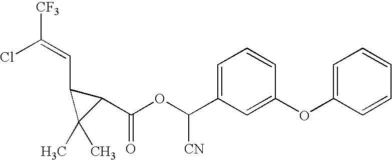

known from DE-A-2 802 962

### B.1.5 Cypermethrin

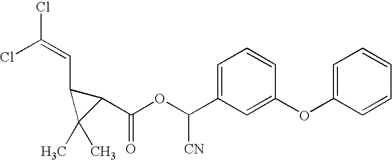

known from DE-A-2 326 077

### B.1.6 Deltamethrin

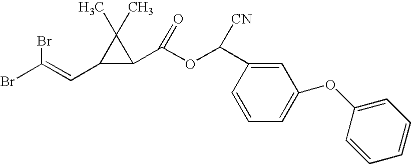

known from DE-A-2 326 077

### B.1.7 Esfenvalerate

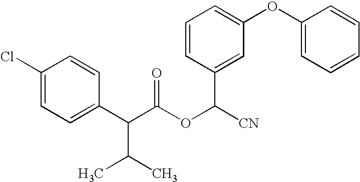

known from DE-A-2 737 297

### B.1.8 Etofenprox

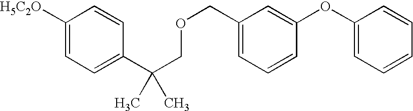

known from DE-A-3 117 510

### B.1.9 Fenpropathrin

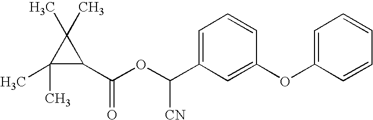

known from DE-A-2 231 312

### B.1.10 Fenvalerate

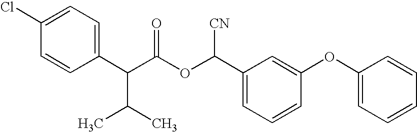

known from DE-A-2 335 347

### B.1.11 Flucythrinate

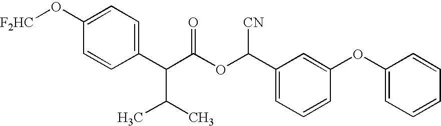

known from DE-A-2 757 066

### B.1.12 Lambda-Cyhalothrin

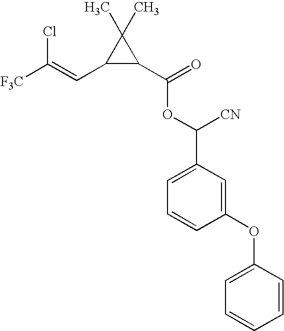

known from EP-A-106 469

### B.1.13 Permethrin

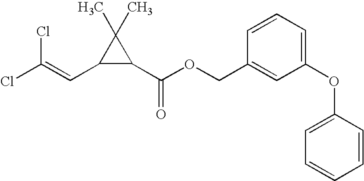

known from DE-A-2 326 077

### B.1.14 Tau-Fluvalinate

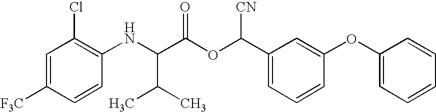

known from EP-A-038 617

### B.1.15 Tralomethrin

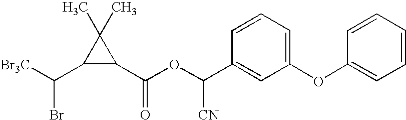

known from DE-A-2 742 546

### B.1.16 Zeta-Cypermethrin

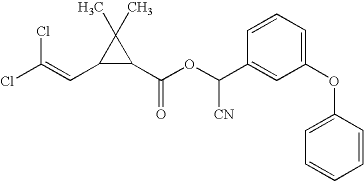

known from EP-A-026 542

### B.1.17 Bifenthrin

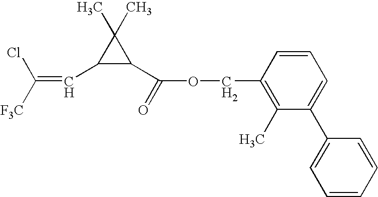

known from EP-A-049 977

### B.2 Indoxacarb

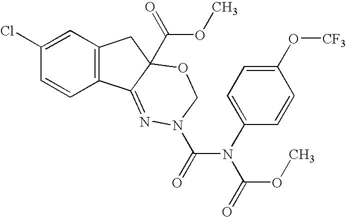

known from WO 92/11249

### (C) Chitin Biosynthesis Inhibitors

### C.1 Benzoylureas

### C.1.1 Chlorfluazuron

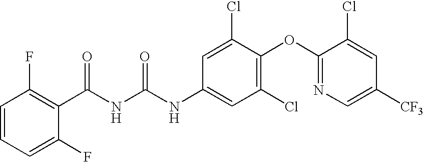

known from DE-A-2 818 830

### C.1.2 Diflubenzuron

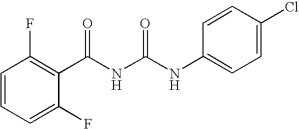

known from DE-A 2 123 236

### C.1.3 Lufenuron

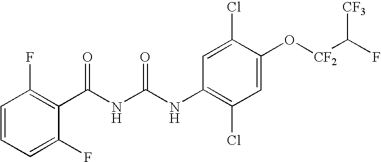

known from EP-A-179 022

### C.1.4 Teflubenzuron

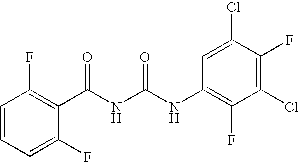

known from EP-A-052 833

### C.1.5 Triflumuron

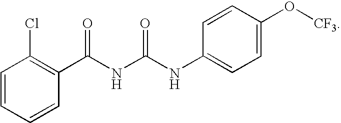

known from DE-A-2 601 780

### C.2 Cyromazine

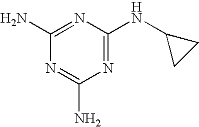

known from DE-A-2 736 876

### (D) Juvenile Hormone Mimetics

### D.1 Fenoxycarb

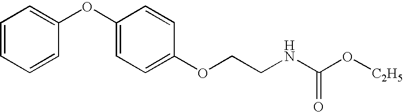

known from EP-A-004 334

### D.2 Diofenolan

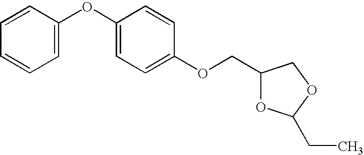

known from DE-A 2 655 910

### D.3. Pyriproxyfen

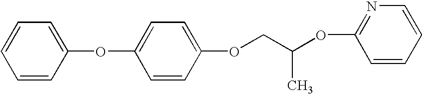

known from EP-A-128 648

### (E) Chloride Channel Activators

### E.1 Macrolides

### E.1.1 Ivermectin

known from EP-A-001 689

### E.1.2 Emamectin

known from EP-A-089 202

### E.1.3 Milbemectin

known from “The Pesticide Manual”, 11th Edition, 1997, p. 846

### E.1.4 Abamectin

known from DE-A-27 170 40

(F) Ecdysone agonists/disruptors

### F.1 Diacylhydrazines

### F.1.1 Methoxyfenozide

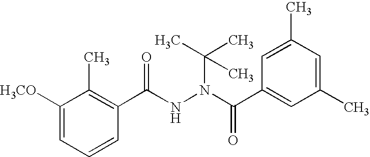

known from EP-A-639 559

### F.1.2 Tebufenozide

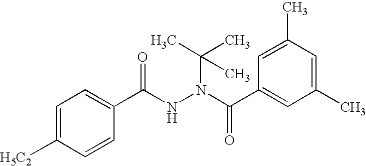

known from EP-A-339 854
(G) GABA-controlled chloride channel antagonists

### G.1 Halocycloalkanes

### G.1.1 Endosulfan

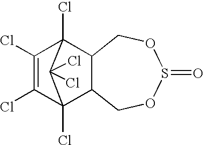

known from DE-A-1 015 797

### G.1.2 Gamma-HCH

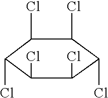

known from U.S. Pat. No. 2,502,258

### G.2 Fiproles

### G.2.1 Fipronil

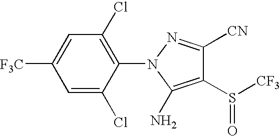

known from EP-A-295 117

### G.2.2 Ethiprole

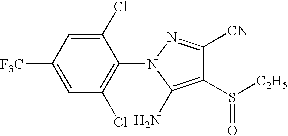

### (H) Acaricides

### H.1 Site-I Electron Transport Inhibitors

### H.1.1 Fenazaquin

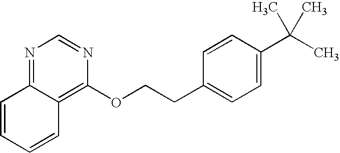

known from EP-A-326 329

### H.1.2 Tebufenpyrad

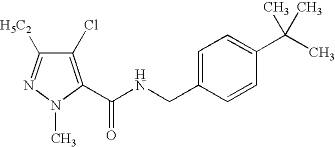

known from EP-A-289 879

### H.1.3 Pyrimidifen

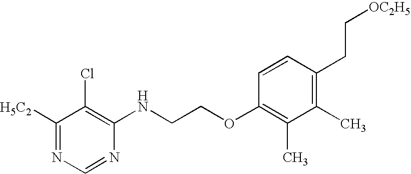

known from EP-A-196 524

### H.1.4 Dicofol

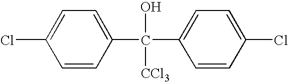

known from U.S. Pat. No. 2,812,280

### H.2 Triarathene

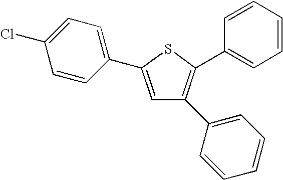

known from DE-A-2 724 494

### H.3 Tetradifon

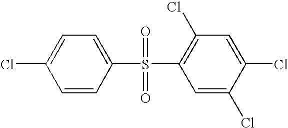

known from U.S. Pat. No. 2,812,281
H.4 Inhibitors of magnesium-stimulated ATPase

### H.4.1 Propargite

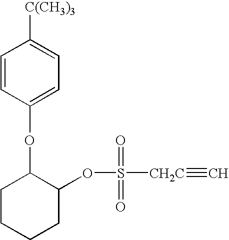

known from U.S. Pat. No. 3,272,854

### H.5 Hexythiazox

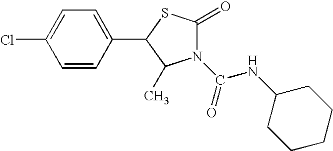

known from DE-A-3 037 105

### H.6 Bromopropylate

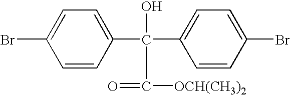

known from U.S. Pat. No. 3,784,696
H.7 2-(Acetyloxy)-3-dodecyl-1,4-naphthalenedione

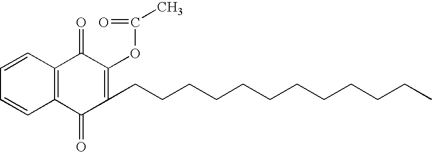

known from DE-A-2 641 343

### (I) Other Compounds

### I.1 Octopaminergic Agonists

### I.1.1 Amitraz

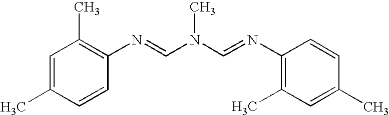

known from DE-A-2 061 132

### I.2 Selective Antifeedants

### I.2.1 Pymetrozine

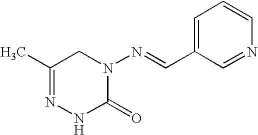

known from EP-A-314 615

### I.3 Biologicals

### I.3.1 Azadirachtin

known from The Pesticide Manual, 11th Edition, 1997, p. 59

### I.3.2 Thuringiensin

known from JP 48033364

### I.3.3 Trichogramma spp.

known from The Pesticide Manual, 11th Edition, 1997, p. 1236

I.3.4 Verticiliium lecanii

known from The Pesticide Manual, 11th Edition, 1997, p. 1266

### I.4 Buprofezin

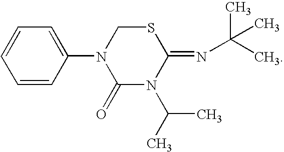

known from DE-A-2 824 126

### I.5 Chinomethionat

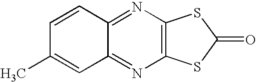

known from DE-A-1 100 372

### I.5 Nereistoxin Analogs

### I.5.1 Thiocyclam Hydrogen Oxalate

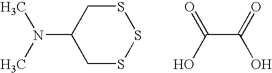

known from DE-A-2 039 666

### I.6 Triazamate

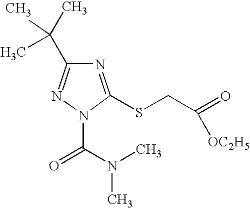

known from EP-A-213 718

### I.7 Acetylcholin Receptor Modulators

of the formula

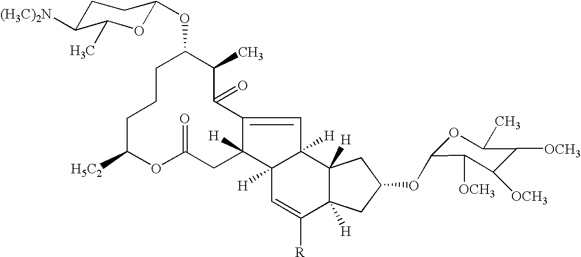

### I.7.1 Spinosad

Mixture of spinosyn A, in which R═H, and spinosyn D, in which R═CH₃, preferably in a ratio of 85% spinosyn A and 15% spinosyn D (see EP-A-0 375 316).

### I.8 Oxidative Phosphorylation Decouplers

### I.8.1 Chlorfenapyr

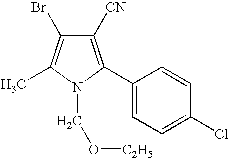

known from EP-A-347 488.

### I.9 Oxidative Phosphorylation Inhibitors

### I.8.1 Diafenthiuron

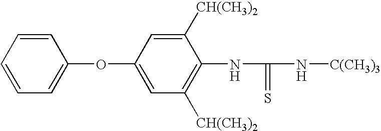

known from EP-A-210 487.
and
(b) at least one crop plant tolerance promoter compound from the following group of compounds:

4-dichloroacetyl-1-oxa-4-azaspiro[4.5]decane (AD-67, MON-4660), 1-dichloroacetylhexahydro-3,3,8a-trimethylpyrrolo[1,2-a]pyrimidin-6(2H)-one (dicyclonon, BAS-145138), 4-dichloroacetyl-3,4-dihydro-3-methyl-2H-1,4-benzoxazine (benoxacor), 1-methylhexyl 5-chloroquinoline-8-oxy-acetate (cloquintocet-mexyl—cf. also related compounds in EP-A-86750, EP-A-94349, EP-A-191736, EP-A-492366), 3-(2-chlorobenzyl)-1-(1-methyl-1-phenylethyl)urea (cumyluron), α-(cyanomethoximino)phenylacetonitrile (cyometrinil), 2,4-dichlorophenoxyacetic acid (2,4-D), 4-(2,4-dichlorophenoxy)butyric acid (2,4-DB), 1-(1-methyl-1-phenylethyl)-3-(4-methylphenyl)urea (daimuron, dymron), 3,6-dichloro-2-methoxybenzoic acid (dicamba), S-1-methyl-1-phenylethyl piperidine-1-thiocarboxylate (dimepiperate), 2,2-dichloro-N-(2-oxo-2-(2-propenylamino)ethyl)-N-(2-propenyl)acetamide (DKA-24), 2,2-dichloro-N,N-di-2-propenylacetamide (dichlormid), 4,6-dichloro-2-phenylpyrimidine (fenclorim), ethyl 1-(2,4-dichlorophenyl)-5-trichloromethyl-1H-1,2,4-triazole-3-carboxylate (fenchlorazole-ethyl—cf. also related compounds in EP-A-174562 and EP-A-346620), phenylmethyl 2-chloro-4-trifluoromethylthiazole-5-carboxylate (flurazole), 4-chloro-N-(1,3-dioxolan-2-ylmethoxy)-α-trifluoroacetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl—cf. also related compounds in WO-A-95/07897), 1-(ethoxycarbonyl)ethyl 3,6-dichloro-2-methoxybenzoate (lactidichlor), (4-chloro-o-tolyloxy)acetic acid (MCPA), 2-(4-chloro-o-tolyloxy)propionic acid (mecoprop), diethyl 1-(2,4-dichorophenyl)-4,5-dihydro-5-methyl-1H-pyrazole-3,5-dicarboxylate (mefenpyrdiethyl—cf. also related compounds in WO-A-91/07874), 2-dichloromethyl-2-methyl-1,3-dioxolane (MG-191), 2-propenyl-1-oxa-4-azaspiro[4.5]decane-4-carbodithioate (MG-838), 1,8-naphthalic anhydride, α-(1,3-dioxolan-2-ylmethoximino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-29148), 4-(4-chloro-o-tolyl)butyric acid, 4-(4-chlorophenoxy)butyric acid, diphenylmethoxyacetic acid, methyl diphenylmethoxyacetate, ethyl diphenylmethoxyacetate, methyl 1-(2-chlorophenyl)-5-phenyl-1H-pyrazole-3-carboxylate, ethyl 1-(2,4-dichlorophenyl)-5-methyl-1H-pyrazole-3-carboxylate, ethyl 1-(2,4-dichlorophenyl)-5-isopropyl-1H-pyrazole-3-carboxylate, ethyl 1-(2,4-dichlorophenyl)-5-(1,1-dimethylethyl)-1H-pyrazole-3-carboxylate, ethyl 1-(2,4-dichlorophenyl)-5-phenyl-1H-pyrazole-3-carboxylate (cf. also related compounds in EP-A-269806 and EP-A-333131), ethyl 5-(2,4-dichlorobenzyl)-2-isoxazoline-3-carboxylate, ethyl 5-phenyl-2-isoxazoline-3-carboxylate, ethyl 5-(4-fluorophenyl)-5-phenyl-2-isoxazoline-3-carboxylate (cf. also related compounds in WO-A-91/08202), 1,3-dimethylbut-1-yl 5-chloroquinoline-8-oxyacetate, 4-allyloxybutyl 5-chloroquinoline-8-oxyacetate, 1-allyloxyprop-2-yl 5-chloroquinoline-8-oxyacetate, methyl 5-chloroquinoxaline-8-oxyacetate, ethyl 5-chloroquinoline-8-oxyacetate, allyl 5-chloroquinoxaline-8-oxyacetate, 2-oxoprop-1-yl 5-chloroquinoline-8-oxyacetate, diethyl 5-chloroquinoline-8-oxymalonate, diallyl 5-chloroquinoxaline-8-oxymalonate, diethyl 5-chloroquinoline-8-oxymalonate (cf. also related compounds in EP-A-582198), 4-carboxychroman-4-ylacetic acid (AC-304415, cf. EP-A-613618), 4-chlorophenoxyacetic acid, 3,3′-dimethyl-4-methoxybenzophenone, 1-bromo-4-chloromethylsulfonylbenzene, 1-[4-(N-2-methoxybenzoylsulfamoyl)phenyl]-3-methylurea (also known as N-(2-methoxybenzoyl)-4-[(methylaminocarbonyl)amino]benzenesulfonamide), 1-[4-(N-2-methoxybenzoylsulfamoyl)phenyl]-3,3-dimethylurea, 1-[4-(N-4,5-dimethylbenzoylsulfamoyl)phenyl]-3-methylurea, 1-[4-(N-naphthylsulfamoyl)phenyl]-3,3-dimethylurea, N-(2-methoxy-5-methylbenzoyl)-4-(cyclopropylaminocarbonyl)benzenesulfonamide,

one of the following compounds, defined by general formulae, of the general formula (IIa)

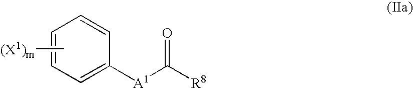

or of the general formula (IIb)

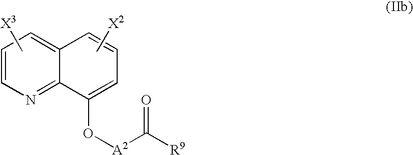

or of the general formula (IIc)

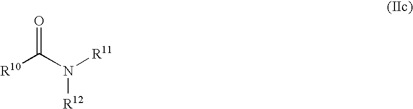

where
m represents a number between 0 and 5,
A¹ represents one of the divalent heterocyclic groupings shown below,

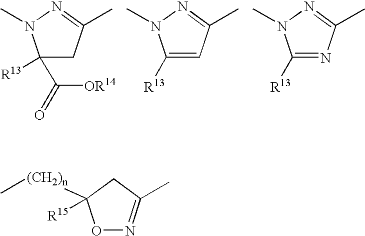

n represents a number between 0 and 5,
A² represents optionally C₁-C₄-alkyl, C₁-C₄-alkoxy-carbonyl- and or C₁-C₄-alkenyloxy-carbonyl-substituted alkanediyl having 1 or 2 carbon atoms,
R⁸ represents hydroxyl, mercapto, amino, C₁-C₆-alkoxy, C₁-C₆-alkylthio, C₁-C₆-alkylamino or di(C₁-C₄-alkyl)amino,
R⁹ represents hydroxyl, mercapto, amino, C₁-C₇-alkoxy, C₁-C₆-alkenyloxy, C₁-C₆-alkenyloxy-C₁-C₆-alkoxy, C₁-C₆-alkylthio, C₁-C₆-alkylamino or di(C₁-C₄-alkyl)amino,
R¹⁰ represents in each case optionally fluorine-, chlorine- and/or bromine-substituted C₁-C₄-alkyl,
R¹¹ represents hydrogen, in each case optionally fluorine-, chlorine- and/or bromine-substituted C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, or optionally fluorine-, chlorine- and/or bromine- or C₁-C₄-alkyl-substituted phenyl,
R¹² represents hydrogen, in each case optionally fluorine-, chlorine- and/or bromine-substituted C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, or optionally fluorine-, chlorine- and/or bromine- or C₁-C₄-alkyl-substituted phenyl, and R¹¹ and R¹² also together represent C₃-C₆-alkanediyl or C₂-C₅-oxaalkanediyl in each case optionally substituted by C₁-C₄-alkyl, phenyl, furyl, a fused benzene ring or by two substituents which, together with the C atom to which they are attached, form a 5- or 6-membered carboxycle,
R¹³ represents hydrogen, cyano, halogen, or represents in each case optionally fluorine-, chlorine- and/or bromine-substituted C₁-C₄-alkyl, C₃-C₆-cycloalkyl or phenyl,
R¹⁴ represents hydrogen, optionally hydroxyl-, cyano-, halogen- or C₁-C₄-alkoxy-substituted C₁-C₆-alkyl, C₃-C₆-cycloalkyl or tri(C₁-C₄-alkyl)silyl,
R¹⁵ represents hydrogen, cyano, halogen, or represents in each case optionally fluorine-, chlorine- and/or bromine-substituted C₁-C₄-alkyl, C₃-C₆-cycloalkyl or phenyl,
X¹ represents nitro, cyano, halogen, C₁-C₄-alkyl, C₁-C₄-haloalkyl, C₁-C₄-alkoxy or C₁-C₄-haloalkoxy,
X² represents hydrogen, cyano, nitro, halogen, C₁-C₄-alkyl, C₁-C₄-haloalkyl, C₁-C₄-alkoxy or C₁-C₄-haloalkoxy,
X³ represents hydrogen, cyano, nitro, halogen, C₁-C₄-alkyl, C₁-C₄-haloalkyl, C₁-C₄-alkoxy or C₁-C₄-haloalkoxy,
   and/or the following compounds, defined by general formulae, of the general formula (IId)

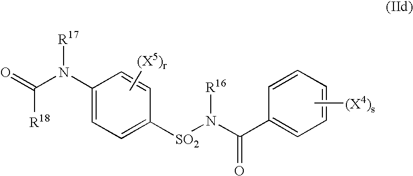

or of the general formula (IIe)

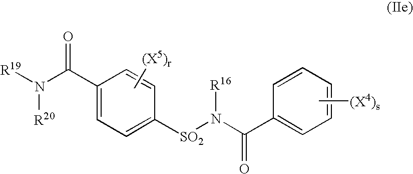

where
r and s represent a number between 0 and 5,
R¹⁶ represents hydrogen or C₁-C₄-alkyl,
R¹⁷ represents hydrogen or C₁-C₄-alkyl,
R¹⁸ represents hydrogen, in each case optionally cyano-, halogen- or C₁-C₄-alkoxy-substituted C₁-C₆-alkyl, C₁-C₆-alkoxy, C₁-C₆-alkylthio, C₁-C₆-alkylamino or di(C₁-C₄-alkyl)amino, or in each case optionally cyano-, halogen- or C₁-C₄-alkyl-substituted C₃-C₆-cycloalkyl, C₃-C₆-cycloalkyloxy, C₃-C₆-cycloalkylthio or C₃-C₆-cycloalkylamino,
R¹⁹ represents hydrogen, optionally cyano-, hydroxyl-, halogen- or C₁-C₄-alkoxy-substituted C₁-C₆-alkyl, in each case optionally cyano- or halogen-substituted C₃-C₆-alkenyl or C₃-C₆-alkynyl, or optionally cyano-, halogen- or C₁-C₄-alkyl-substituted C₃-C₆-cycloalkyl,
R²⁰ represents hydrogen, optionally cyano-, hydroxyl-, halogen- or C₁-C₄-alkoxy-substituted C₁-C₆-alkyl, in each case optionally cyano- or halogen-substituted C₃-C₆-alkenyl or C₃-C₆-alkynyl, optionally cyano-, halogen- or C₁-C₄-alkyl-substituted C₃-C₆-cycloalkyl, or optionally nitro-, cyano-, halogen-, C₁-C₄-alkyl-, C₁-C₄-haloalkyl-, C₁-C₄-alkoxy- or C₁-C₄-haloalkoxy-substituted phenyl, or together with R¹⁹ represents in each case optionally C₁-C₄-alkyl-substituted C₂-C₆-alkanediyl or C₂-C₅-oxaalkanediyl,
X⁴ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy or C₁-C₄-haloalkoxy, and
X⁵ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy or C₁-C₄-haloalkoxy,
   which can be used for controlling insects.

In the definitions the hydrocarbon chains, as in alkyl, alkenyl or alkanediyl, and also in conjunction with heteroatoms, such as in alkoxy, are in each case linear or branched.

Optionally substituted radicals may unless indicated otherwise be substituted one or more times, and in the case of multiple substitutions the substituents may be alike or different.

The radical definitions or elucidations set out below in general or in ranges of preference may be combined with one another arbitrarily, thus including arbitrary combinations between the respective ranges of generality and ranges of preference.

The compounds of the formula (IV-a), (IV-b), (IV-c), (IV-d) and (IV-e), as they are and/or in dependence on the nature of the substituents, may be present in the form of geometrical and/or optical isomers or isomer mixtures, in varying composition, which if desired may be separated in conventional fashion. Not only the pure isomers but also the isomer mixtures can be used in the compositions of the invention and put to the inventive use. In the text below, however, for the sake of simplicity, the reference is always to compounds of the formula (IV-a), (IV-b), (IV-c), (IV-d) and (IV-e), although such references embrace not only the pure compounds but also, where appropriate, mixtures with different proportions of isomeric compounds.

Preferred definitions of the groups listed above in connection with the crop plant tolerance promoter compounds (herbicide safeners) of the formulae (IIa), (IIb), (IIc), (IId) and (IIe), are defined below.
m preferably represents the numbers 0, 1, 2, 3 or 4.
A¹ preferably represents one of the divalent heterocyclic groupings shown below

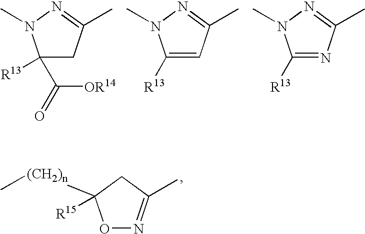

n preferably represents the numbers 0, 1, 2, 3 or 4.
A² preferably represents in each case optionally methyl-, ethyl-, methoxycarbonyl- or ethoxycarbonyl-substituted methylene or ethylene.
R⁸ preferably represents hydroxyl, mercapto, amino, methoxy, ethoxy, n- or i-propoxy, n-, i-, s- or t-butoxy, methylthio, ethylthio, n- or i-propylthio, n-, i-, s- or t-butylthio, methylamino, ethylamino, n- or i-propylamino, n-, i-, s- or t-butylamino, dimethylamino or diethylamino.
R⁹ preferably represents hydroxyl, mercapto, amino, methoxy, ethoxy, n- or i-propoxy, n-, i-, s- or t-butoxy, 1-methylhexyloxy, allyloxy, 1-allyloxymethylethoxy, methylthio, ethylthio, n- or i-propylthio, n-, i-, s- or t-butylthio, methylamino, ethylamino, n- or i-propylamino, n-, i-, s- or t-butylamino, dimethylamino or diethylamino.
R¹⁰ preferably represents in each case optionally fluorine-, chlorine- and/or bromine-substituted methyl, ethyl, n- or i-propyl.
R¹¹ preferably represents hydrogen, in each case optionally fluorine- and/or chlorine-substituted methyl, ethyl, n- or i-propyl, n-, i-, s- or t-butyl, propenyl, butenyl, propynyl or butynyl, methoxymethyl, ethoxymethyl, methoxyethyl, ethoxyethyl, dioxolanylmethyl, furyl, furylmethyl, thienyl, thiazolyl, piperidinyl, or optionally fluorine-, chlorine-, methyl-, ethyl-, n- or i-propyl-, n-, i-, s- or t-butyl-substituted phenyl.
R¹² preferably represents hydrogen, in each case optionally fluorine- and/or chlorine-substituted methyl, ethyl, n- or i-propyl, n-, i-, s- or t-butyl, propenyl, butenyl, propynyl or butynyl, methoxymethyl, ethoxymethyl, methoxyethyl, ethoxyethyl, dioxolanylmethyl, furyl, furylmethyl, thienyl, thiazolyl, piperidinyl, or optionally fluorine-, chlorine-, methyl-, ethyl-, n- or i-propyl-, n-, i-, s- or t-butyl-substituted phenyl, or together with R¹¹ represents one of the radicals —CH₂—O—CH₂—CH₂— and —CH₂—CH₂—O—CH₂—CH₂— which are optionally substituted by methyl, ethyl, furyl, phenyl, a fused benzene ring or by two substituents which, together with the C atom to which they are attached, form a 5- or 6-membered carbocycle.
R¹³ preferably represents hydrogen, cyano, fluorine, chlorine, bromine, or represents in each case optionally fluorine-, chlorine- and/or bromine-substituted methyl, ethyl, n- or i-propyl, cyclopropyl, cyclobutyl, cyclopentyl, cyclohexyl or phenyl.
R¹⁴ preferably represents hydrogen, optionally hydroxyl-, cyano-, fluorine-, chlorine-, methoxy-, ethoxy-, n- or i-propoxy-substituted methyl, ethyl, n- or i-propyl, n-, i-, s- or t-butyl.
R¹⁵ preferably represents hydrogen, cyano, fluorine, chlorine, bromine, or represents in each case optionally fluorine-, chlorine- and/or bromine-substituted methyl, ethyl, n- or i-propyl, n-, i-, s- or t-butyl, cyclopropyl, cyclobutyl, cyclopentyl, cyclohexyl or phenyl.
X¹ preferably represents nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
X² preferably represents hydrogen, nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
X³ preferably represents hydrogen, nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
r preferably represents one of the numbers 0, 1, 2, 3 or 4.
s preferably represents one of the numbers 0, 1, 2, 3 or 4.
R¹⁶ preferably represents hydrogen, methyl, ethyl, n- or i-propyl.
R¹⁷ preferably represents hydrogen, methyl, ethyl, n- or i-propyl.
R¹⁸ preferably represents hydrogen, in each case optionally cyano-, fluorine-, chlorine-, methoxy-, ethoxy-, n- or i-propoxy-substituted methyl, ethyl, n- or i-propyl, n-, i-, s- or t-butyl, methoxy, ethoxy, n- or i-propoxy, n-, i-, s- or t-butoxy, methylthio, ethylthio, n- or i-propylthio, n-, i-, s- or t-butylthio, methylamino, ethylamino, n- or i-propylamino, n-, i-, s- or t-butylamino, dimethylamino or diethylamino, or in each case optionally cyano-, fluorine-, chlorine-, bromine-, methyl-, ethyl-, n- or i-propyl-substituted cyclopropyl, cyclobutyl, cyclopentyl, cyclohexyl, cyclopropyloxy, cyclobutyloxy, cyclopentyloxy, cyclohexyloxy, cyclopropylthio, cyclobutylthio, cyclopentylthio, cyclohexylthio, cyclopropylamino, cyclobutylamino, cyclopentylamino or cyclohexylamino.
R¹⁹ preferably represents hydrogen, in each case optionally cyano-, hydroxyl-, fluorine-, chlorine-, methoxy-, ethoxy-, n- or i-propoxy-substituted methyl, ethyl, n- or i-propyl, n-, i- or s-butyl, in each case optionally cyano-, fluorine-, chlorine- or bromine-substituted propenyl, butenyl, propynyl or butynyl, or in each case optionally cyano-, fluorine-, chlorine-, bromine-, methyl-, ethyl-, n- or i-propyl-substituted cyclopropyl, cyclobutyl, cyclopentyl or cyclohexyl.
R²⁰ preferably represents hydrogen, in each case optionally cyano-, hydroxyl-, fluorine-, chlorine-, methoxy-, ethoxy-, n- or i-propoxy-substituted methyl, ethyl, n- or i-propyl, n-, i- or s-butyl, in each case optionally cyano-, fluorine-, chlorine- or bromine-substituted propenyl, butenyl, propynyl or butynyl, in each case optionally cyano-, fluorine-, chlorine-, bromine-, methyl-, ethyl-, n- or i-propyl-substituted cyclopropyl, cyclobutyl, cyclopentyl or cyclohexyl, or optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy- or trifluoromethoxy-substituted phenyl, or together with R¹⁹ represents in each case optionally methyl- or ethyl-substituted butane-1,4-diyl (trimethylene), pentane-1,5-diyl, 1-oxabutane-1,4-diyl or 3-oxapentane-1,5-diyl.
X⁴ preferably represents nitro, cyano, carboxyl, carbamoyl, formyl, sulphamoyl, hydroxyl, amino, fluorine, chlorine, bromine, methyl, ethyl, n- or i-propyl, n-, i-, s- or t-butyl, trifluoromethyl, methoxy, ethoxy, n- or i-propoxy, difluoromethoxy or trifluoromethoxy.
X⁵ preferably represents nitro, cyano, carboxyl, carbamoyl, formyl, sulphamoyl, hydroxyl, amino, fluorine, chlorine, bromine, methyl, ethyl, n- or i-propyl, n-, i-, s- or t-butyl, trifluoromethyl, methoxy, ethoxy, n- or i-propoxy, difluoromethoxy or trifluoromethoxy.

Examples of the compounds of the formula (IIa) which are very particularly preferred as herbicide safeners of the invention are listed in the table below.

TABLE
Examples of the compounds of the formula (IIa)

| | |
|---|---|
| | (IIa) |
| 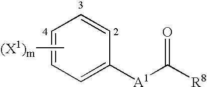 | |

| Example | (Positions) | | |
|---|---|---|---|
| No. | (X¹)ₘ | A¹ | R⁸ |
| IIa-1 | (2) Cl, (4) Cl | 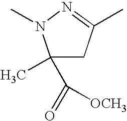 | OCH₃ |
| IIa-2 | (2) Cl, (4) Cl | 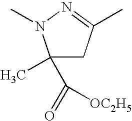 | OCH₃ |
| IIa-3 | (2) Cl, (4) Cl | 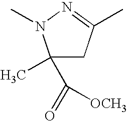 | OC₂H₅ |
| IIa-4 | (2) Cl, (4) Cl | 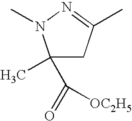 | OC₂H₅ |
| IIa-5 | (2) Cl | 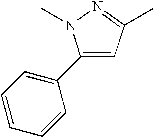 | OCH₃ |
| IIa-6 | (2) Cl, (4) Cl | 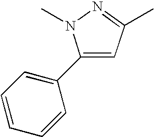 | OCH₃ |
| IIa-7 | (2) F | 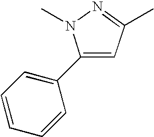 | OCH₃ |
| IIa-8 | (2) F | 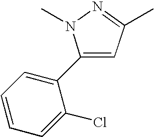 | OCH₃ |
| IIa-9 | (2) Cl, (4) Cl | 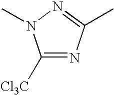 | OC₂H₅ |
| IIa-10 | (2) Cl, (4) CF₃ | 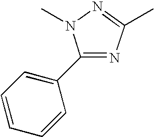 | OCH₃ |
| IIa-11 | (2) Cl | 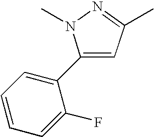 | OCH₃ |
| IIa-12 | — | 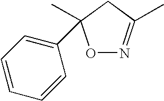 | OC₂H₅ |
| IIa-13 | (2) Cl, (4) Cl | 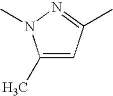 | OC₂H₅ |
| IIa-14 | (2) Cl, (4) Cl | 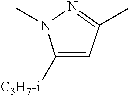 | OC₂H₅ |
| IIa-15 | (2) Cl, (4) Cl | 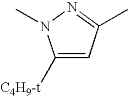 | OC₂H₅ |
| IIa-16 | (2) Cl, (4) Cl | 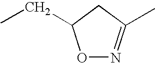 | OC₂H₅ |
| IIa-17 | (2) Cl, (4) Cl | 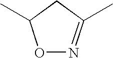 | OC₂H₅ |
| IIa-18 | — | 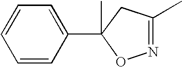 | OH |

Examples of the compounds of the formula (IIb) which are very particularly preferred as herbicide safeners of the invention are listed in the table below.

TABLE
Examples of the compounds of the formula (IIb)

| | |
|---|---|
| | (IIb) |
| 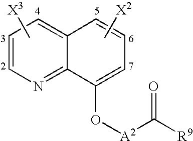 | |

| Example | (Position) | (Position) | | |
|---|---|---|---|---|
| No. | X² | X³ | A² | R⁹ |
| IIb-1 | (5) Cl | — | CH₂ | OH |
| IIb-2 | (5) Cl | — | CH₂ | OCH₃ |
| IIb-3 | (5) Cl | — | CH₂ | OC₂H₅ |
| IIb-4 | (5) Cl | — | CH₂ | OC₃H₇-n |
| IIb-5 | (5) Cl | — | CH₂ | OC₃H₇-i |
| IIb-6 | (5) Cl | — | CH₂ | OC₄H₉-n |
| IIb-7 | (5) Cl | — | CH₂ | OCH(CH₃)C₅H₁₁-n |
| IIb-8 | (5) Cl | (2) F | CH₂ | OH |
| IIb-9 | (5) Cl | (2) Cl | CH₂ | OH |
| IIb-10 | (5) Cl | — | CH₂ | OCH₂CH═CH₂ |
| IIb-11 | (5) Cl | — | CH₂ | OC₄H₉-i |
| IIb-12 | (5) Cl | — | CH₂ | 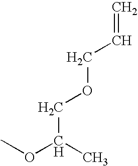 |
| IIb-13 | (5) Cl | — | 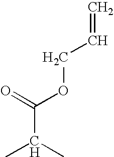 | OCH₂CH═CH₂ |
| IIb-14 | (5) Cl | — | 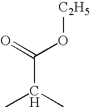 | OC₂H₅ |
| IIb-15 | (5) Cl | — | 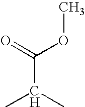 | OCH₃ |

Examples of the compounds of the formula (IIc) which are very particularly preferred as herbicide safeners of the invention are listed in the table below.

TABLE
Examples of the compunds of the formula (IIc)

| | |
|---|---|
| | (IIc) |
| 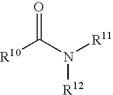 | |

| Example | | |
|---|---|---|
| No. | R¹⁰ | N(R¹¹, R¹²) |
| IIc-1 | CHCl₂ | N(CH₂CH═CH₂)₂ |
| IIc-2 | CHCl₂ | 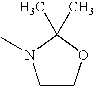 |
| IIc-3 | CHCl₂ | 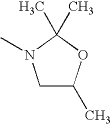 |
| IIc-4 | CHCl₂ | 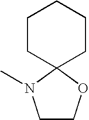 |
| IIc-5 | CHCl₂ | 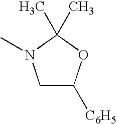 |
| IIc-6 | CHCl₂ | 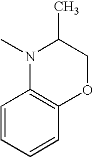 |
| IIc-7 | CHCl₂ | 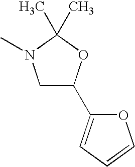 |

Examples of the compounds of the formula (IId) which are very particularly preferred as herbicide safeners of the invention are listed in the table below.

TABLE
Examples of the compounds of the formula (IId)

| | |
|---|---|
| | (IId) |
| 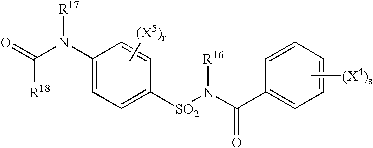 | |

| Example | | | | (Positions) | (Positions) |
|---|---|---|---|---|---|
| No. | R¹⁶ | R¹⁷ | R¹⁸ | (X⁴)ₛ | (X⁵)ᵣ |
| IId-1 | H | H | CH₃ | (2) OCH₃ | — |
| IId-2 | H | H | C₂H₅ | (2) OCH₃ | — |
| IId-3 | H | H | C₃H₇-n | (2) OCH₃ | — |
| IId-4 | H | H | C₃H₇-i | (2) OCH₃ | — |
| IId-5 | H | H | 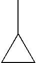 | (2) OCH₃ | — |
| IId-6 | H | H | CH₃ | (2) OCH₃ | — |
| | | | | (5) CH₃ | |
| IId-7 | H | H | C₂H₅ | (2) OCH₃ | — |
| | | | | (5) CH₃ | |
| IId-8 | H | H | C₃H₇-n | (2) OCH₃ | — |
| | | | | (5) CH₃ | |
| IId-9 | H | H | C₃H₇-i | (2) OCH₃ | — |
| | | | | (5) CH₃ | |
| IId-10 | H | H | 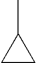 | (2) OCH₃(5) CH₃ | — |
| IId-11 | H | H | OCH₃ | (2) OCH₃ | — |
| | | | | (5) CH₃ | |
| IId-12 | H | H | OC₂H₅ | (2) OCH₃ | — |
| | | | | (5) CH₃ | |
| IId-13 | H | H | OC₃H₇-i | (2) OCH₃ | — |
| | | | | (5) CH₃ | |
| IId-14 | H | H | SCH₃ | (2) OCH₃ | — |
| | | | | (5) CH₃ | |
| IId-15 | H | H | SC₂H₅ | (2) OCH₃ | — |
| | | | | (5) CH₃ | |
| IId-16 | H | H | SC₃H₇-i | (2) OCH₃ | — |
| | | | | (5) CH₃ | |
| IId-17 | H | H | NHCH₃ | (2) OCH₃ | — |
| | | | | (5) CH₃ | |
| IId-18 | H | H | NHC₂H₅ | (2) OCH₃ | — |
| | | | | (5) CH₃ | |
| IId-19 | H | H | NHC₃H₇-i | (2) OCH₃ | — |
| | | | | (5) CH₃ | |
| IId-20 | H | H | 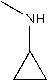 | (2) OCH₃(5) CH₃ | — |
| IId-21 | H | H | NHCH₃ | (2) OCH₃ | — |
| IId-22 | H | H | NHC₃H₇-i | (2) OCH₃ | — |
| IId-23 | H | H | N(CH₃)₂ | (2) OCH₃ | — |
| IId-24 | H | H | N(CH₃)₂ | (3) CH₃ | — |
| | | | | (4) CH₃ | |
| IId-25 | H | H | CH₂—O—CH₃ | (2) OCH₃ | — |

Examples of the compounds of formula (IIe) which are very particularly preferred as herbicide safeners of the invention are listed in the table below.

TABLE
Examples of the compounds of the formula (IIe)

| | |
|---|---|
| | (IIe) |
| 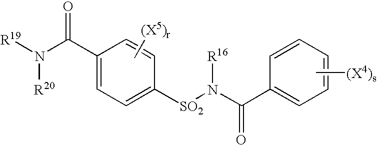 | |

| Example | | | | (Positions) | (Positions) |
|---|---|---|---|---|---|
| No. | R¹⁶ | R¹⁹ | R²⁰ | (X⁴)ₛ | (X⁵)ᵣ |
| IIe-1 | H | H | CH₃ | (2) OCH₃ | — |
| IIe-2 | H | H | C₂H₅ | (2) OCH₃ | — |
| IIe-3 | H | H | C₃H₇-n | (2) OCH₃ | — |
| IIe-4 | H | H | C₃H₇-i | (2) OCH₃ | — |
| IIe-5 | H | H | 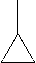 | (2) OCH₃ | — |
| IIe-6 | H | CH₃ | CH₃ | (2) OCH₃ | — |
| IIe-7 | H | H | CH₃ | (2) OCH₃ | — |
| | | | | (5) CH₃ | |
| IIe-8 | H | H | C₂H₅ | (2) OCH₃ | — |
| | | | | (5) CH₃ | |
| IIe-9 | H | H | C₃H₇-n | (2) OCH₃ | — |
| | | | | (5) CH₃ | |
| IIe-10 | H | H | C₃H₇-i | (2) OCH₃ | — |
| | | | | (5) CH₃ | |
| IIe-11 | H | H | 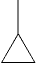 | (2) OCH₃(5) CH₃ | — |
| IIe-12 | H | CH₃ | CH₃ | (2) OCH₃ | — |
| | | | | (5) CH₃ | |

Preference is given in accordance with the invention to active ingredient combinations comprising in each case at least one of the active ingredients selected from one of groups (A) to (I) and in each case at least one of the abovementioned safeners.

As the crop plant tolerance promoter compound [component (b)], cloquintocet-mexyl, fenchlorazole-ethyl, isoxadifen-ethyl, mefenpyr-diethyl, furilazole, fenclorim, cumyluron, dymron, dimepiperate and the compounds IIe-5 and IIe-11 are most preferred, with particular emphasis being given to cloquintocet-mexyl and mefenpyr-diethyl.

Preferred combinations comprise the crop plant tolerance promoter compound cloquintocet-mexyl and an active ingredient selected from group (A), (B), (C), (D), (E), (F), (G), (H) or (I). Examples of these combinations are mixtures, for example, comprising cloquintocet-mexyl and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound fenchlorazole-ethyl and an active ingredient selected from group (A), (B), (C), (D), (E), (F), (G), (H) or (1). Examples of these combinations are mixtures, for example, comprising fenchlorazole-ethyl and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound isoxadifen-ethyl and an active ingredient selected from group (A), (B), (C), (D), (E), (F), (G), (H) or (I). Examples of these combinations are mixtures, for example, comprising isoxadifen-ethyl and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound mefenpyr-diethyl and an active ingredient selected from group (A), (B), (C), (D), (E), (F), (G), (H) or (I). Examples of these combinations are mixtures, for example, comprising mefenpyr-diethyl and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound flurilazole and an active ingredient selected from group (A), (B), (C), (D), (E), (F), (G), (H) or (I). Examples of these combinations are mixtures, for example, comprising flurilazole and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound fenclorim and an active ingredient selected from group (A), (B), (C), (D), (E), (F), (G), (H) or (I). Examples of these combinations are mixtures, for example, comprising fenclorim and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound cumyluron and an active ingredient selected from group (A), (B), (C), (D), (E), (F), (G), (H) or (I). Examples of these combinations are mixtures, for example, comprising cumyluron and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound dymron and an active ingredient selected from group (A), (B), (C), (D), (E), (F), (G), (H) or (I). Examples of these combinations are mixtures, for example, comprising dymron and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound dimepiperate and an active ingredient selected from group (A), (B), (C), (D), (E), (F), (G), (H) or (I). Examples of these combinations are mixtures, for example, comprising dimepiperate and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound IIe-11 and an active ingredient selected from group (A), (B), (C), (D), (E), (F), (G), (H) or (D). Examples of these combinations are mixtures, for example, comprising the compound IIe-11 and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

Preferred combinations comprise the crop plant tolerance promoter compound IIe-5 and an active ingredient selected from group (A), (B), (C), (D), (E), (F), (G), (H) or (I). Examples of these combinations are mixtures, for example, comprising IIe-5 and pirimicarb, indoxacarb, cyromazine, abamectin, tebufenozide, fipronil, 2-(acetyloxy)-3-dodecyl-1,4-naphthalenedione, diafenthiuron, chlorfenapyr, spinosad, thuringiensin or pymetrozine.

The compounds of the general formula (IIa) for use as safeners are known and/or can be prepared by methods known per se (cf. WO-A-91/07874, WO-A-95/07897).

The compounds of the general formula (IIb) for use as safeners are known and/or can be prepared by methods known per se (cf. EP-A-191736).

The compounds of the general formula (IIc) for use as safeners are known and/or can be prepared by methods known per se (cf. DE-A-2218097, DE-A-2350547).

The compounds of the general formula (IId) for use as safeners are known and/or can be prepared by methods known per se (cf. DE-A-19621522/U.S. Pat. No. 6,235,680).

The compounds of the general formula (IIe) for use as safeners are known and/or can be prepared by methods known per se (cf. WO-A-99/66795/U.S. Pat. No. 6,251,827).

It has now surprisingly been found that the above-defined active ingredient combinations comprising the compounds of groups (A) to (I) in the safeners (antidotes) from group (b) listed above combine enhanced crop plant tolerance with high insecticidal activity and can be used for controlling pests in a variety of crops.

In this context it is considered completely surprising that compounds from group (b) set out above boost the insecticidal activity of the compounds of groups (A) to (I) in some cases so that a synergistic effect is recorded.

Emphasis may be given in this context to the particularly advantageous effect of the particularly preferred combination partners from group (b), particularly in respect of application in cereal plants, such as wheat, oats, barley, triticale and rye, for example, but also maize, millet, rice, sugarcane, soybean, potato, cotton, oilseed rape, tobacco, hops, and fruit plants (encompassing pome fruit such as, for example, apples and pears, stone fruit such as, for example, peaches, nectarines, cherries, plums and apricots, citrus fruits such as, for example, oranges, grapefruits, limes, lemons, cumquats, mandarins and satsumas, nuts such as, for example, pistacchios, almonds, walnuts and pecan nuts, tropical fruits such as, for example, mango, papaya, pineapple, dates and bananas, and grapes).

The combinations can also be used to protect vegetables. These include, among others, artichokes, aubergines, cauliflower, broccoli, green beans, peas, fennel, chicory, cucumber, kohlrabi, lettuce, cress, leeks, Swiss chard, carrots, bell peppers, rhubarb, beetroot, red cabbage, Brussels sprouts, celeriac, turnips, tomatoes, savoy cabbage, chestnuts, runner beans, scorzonera, corn, asparagus, table beet, spinach, white cabbage, savoy cabbage, onions, zucchini.

The active ingredient combinations can thus be used in general in connection with the following plants: dicotyledonous crops of the following genera: Gossypium, Glycine, Beta, Daucus, Phaseolus, Pisum, Solanum, Linum, Ipomoea, Vicia, Nicotiana, Lycopersicon, Arachis, Brassica, Lactuca, Cucumis, Cucurbita, Helianthus.

Monocotyledonous crops of the following genera: Oryza, Zea, Triticum, Hordeum, Avena, Secale, Sorghum, Panicum, Saccharum, Ananas, Asparagus, Allium.

The use of the active ingredient combinations, however, is by no means restricted to these genera, but instead extends in the same way to other plants as well.

The advantageous effect of crop plant tolerance of the active ingredient combinations is particularly strongly pronounced for certain concentration ratios. It is possible, however, for the weight ratios of the active ingredients in the active ingredient combinations to be varied within relatively wide ranges. In general, per part by weight of active ingredient of group (A) to (I) or a salt thereof, there are 0.001 to 1000 parts by weight, preferably 0.01 to 100 parts by weight, more preferably 0.05 to 10 parts by weight and most preferably 0.07 to 1.5 parts by weight of one of the crop plant tolerance promoter compounds (antidotes/safeners) specified above under (b).

The inventive combinations of the active ingredients of groups (A) to (I) and the safeners of group (b) can be used, for example, in the preferred and particularly preferred mixing ratios indicated in the table below. These mixing ratios are based on weight ratios. The ratio is to be understood as representing active ingredient from one of groups (A) to (I):cocomponent from group (b). The ratio is to be understood preferably as active ingredient from groups (A) to (I) (“cocomponent”) and in each case one of the active ingredients cloquintocet-mexyl, fenchlorazole-ethyl, isoxadifen-ethyl, mefenpyr-diethyl, furilazole, fenclorim, cumyluron, dymron, dimepiperate, compound IIe-5 or compound IIe-11.

TABLE

| | | particularly |
|---|---|---|
| Cocomponent | preferred ratio | preferred ratio |
| 2-(Acetyloxy)-3-dodecyl- | 500:1 to 1:500 | 100:1 to 1:100 |
| 1,4-naphthalenidone | | |
| Acephate | 500:1 to 1:500 | 100:1 to 1:100 |
| Acrinathrin | 500:1 to 1:500 | 100:1 to 1:100 |
| Alpha-Cypermethrin | 500:1 to 1:500 | 100:1 to 1:100 |
| Amitraz | 500:1 to 1:500 | 100:1 to 1:100 |
| Azadirachtin | 500:1 to 1:500 | 100:1 to 1:100 |
| Azinphosmethyl | 500:1 to 1:500 | 100:1 to 1:100 |
| Beta-Cyfluthrin | 500:1 to 1:500 | 100:1 to 1:100 |
| Bromopropylate | 500:1 to 1:500 | 100:1 to 1:100 |
| Buprofezin | 500:1 to 1:500 | 100:1 to 1:100 |
| Carbaryl | 500:1 to 1:500 | 100:1 to 1:100 |
| Chinomethionat | 500:1 to 1:500 | 100:1 to 1:100 |
| Chlorfenvinphos | 500:1 to 1:500 | 100:1 to 1:100 |
| Chlorfluazuron | 500:1 to 1:500 | 100:1 to 1:100 |
| Chlorpyrifos | 500:1 to 1:500 | 100:1 to 1:100 |
| Cyhalothrin | 500:1 to 1:500 | 100:1 to 1:100 |
| Cypermethrin | 500:1 to 1:500 | 100:1 to 1:100 |
| Cyromazin | 500:1 to 1:500 | 100:1 to 1:100 |
| Deltamethrin | 500:1 to 1:500 | 100:1 to 1:100 |
| Diazinon | 500:1 to 1:500 | 100:1 to 1:100 |
| Dichlorphos | 500:1 to 1:500 | 100:1 to 1:100 |
| Dicofol | 500:1 to 1:500 | 100:1 to 1:100 |
| Dicrotophos | 500:1 to 1:500 | 100:1 to 1:100 |
| Diflubenzuron | 500:1 to 1:500 | 100:1 to 1:100 |
| Dimethoate | 500:1 to 1:500 | 100:1 to 1:100 |
| Diofenolan | 500:1 to 1:500 | 100:1 to 1:100 |
| Disulfoton | 500:1 to 1:500 | 100:1 to 1:100 |
| Emamectin | 500:1 to 1:500 | 100:1 to 1:100 |
| Endosulfan | 500:1 to 1:500 | 100:1 to 1:100 |
| Esfenvalerate | 500:1 to 1:500 | 100:1 to 1:100 |
| Ethion | 500:1 to 1:500 | 100:1 to 1:100 |
| Etofenprox | 500:1 to 1:500 | 100:1 to 1:100 |
| Fenazaquin | 500:1 to 1:500 | 100:1 to 1:100 |
| Fenitrothion | 500:1 to 1:500 | 100:1 to 1:100 |
| Fenoxycarb | 500:1 to 1:500 | 100:1 to 1:100 |
| Fenpropathrin | 500:1 to 1:500 | 100:1 to 1:100 |
| Fenpyrad (Tebufenpyrad) | 500:1 to 1:500 | 100:1 to 1:100 |
| Fenthion | 500:1 to 1:500 | 100:1 to 1:100 |
| Fenvalerate | 500:1 to 1:500 | 100:1 to 1:100 |
| Fipronil | 500:1 to 1:500 | 100:1 to 1:100 |
| Flucythrinat | 500:1 to 1:500 | 100:1 to 1:100 |
| Formetanate | 500:1 to 1:500 | 100:1 to 1:100 |
| (hydrochloride) | | |
| Hexyhiazox | 500:1 to 1:500 | 100:1 to 1:100 |
| Indoxacarb | 500:1 to 1:500 | 100:1 to 1:100 |
| Isoxathion | 500:1 to 1:500 | 100:1 to 1:100 |
| Ivermectin | 500:1 to 1:500 | 100:1 to 1:100 |
| Lambda-Cyhalothrin | 500:1 to 1:500 | 100:1 to 1:100 |
| Lindane (gamma-HCH) | 500:1 to 1:500 | 100:1 to 1:100 |
| Lufenuron | 500:1 to 1:500 | 100:1 to 1:100 |
| Malathion | 500:1 to 1:500 | 100:1 to 1:100 |
| Methamidophos | 500:1 to 1:500 | 100:1 to 1:100 |
| Methidathion | 500:1 to 1:500 | 100:1 to 1:100 |
| Methiocarb | 500:1 to 1:500 | 100:1 to 1:100 |
| Methomyl | 500:1 to 1:500 | 100:1 to 1:100 |
| Methoxyfenozide | 500:1 to 1:500 | 100:1 to 1:100 |
| Mevinphos | 500:1 to 1:500 | 100:1 to 1:100 |
| Milbemectin | 500:1 to 1:500 | 100:1 to 1:100 |
| Monocrotophos | 500:1 to 1:500 | 100:1 to 1:100 |
| Oxamyl | 500:1 to 1:500 | 100:1 to 1:100 |
| Oxydemeton-methyl | 500:1 to 1:500 | 100:1 to 1:100 |
| Parathion | 500:1 to 1:500 | 100:1 to 1:100 |
| Parathion-methyl | 500:1 to 1:500 | 100:1 to 1:100 |
| Permethrin | 500:1 to 1:500 | 100:1 to 1:100 |
| Phenthoate | 500:1 to 1:500 | 100:1 to 1:100 |
| Phorate | 500:1 to 1:500 | 100:1 to 1:100 |
| Phosalone | 500:1 to 1:500 | 100:1 to 1:100 |
| Phosmet | 500:1 to 1:500 | 100:1 to 1:100 |
| Phosphamidon | 500:1 to 1:500 | 100:1 to 1:100 |
| Phoxim | 500:1 to 1:500 | 100:1 to 1:100 |
| Pirimicarb | 500:1 to 1:500 | 100:1 to 1:100 |
| Pirimiphos-methyl | 500:1 to 1:500 | 100:1 to 1:100 |
| Profenofos | 500:1 to 1:500 | 100:1 to 1:100 |
| Propargite | 500:1 to 1:500 | 100:1 to 1:100 |
| Propoxur | 500:1 to 1:500 | 100:1 to 1:100 |
| Prothiofos | 500:1 to 1:500 | 100:1 to 1:100 |
| Pymetrozine | 500:1 to 1:500 | 100:1 to 1:100 |
| Pyrimidifen | 500:1 to 1:500 | 100:1 to 1:100 |
| Pyriproxyfen | 500:1 to 1:500 | 100:1 to 1:100 |
| Tau-Fluvalinate | 500:1 to 1:500 | 100:1 to 1:100 |
| Tebufenozide | 500:1 to 1:500 | 100:1 to 1:100 |
| Tebupyrimfos | 500:1 to 1:500 | 100:1 to 1:100 |
| Teflubenzuron | 500:1 to 1:500 | 100:1 to 1:100 |
| Tetradifon | 500:1 to 1:500 | 100:1 to 1:100 |
| Thiocyclam | 500:1 to 1:500 | 100:1 to 1:100 |
| Thiodicarb | 500:1 to 1:500 | 100:1 to 1:100 |
| Tralomethrin | 500:1 to 1:500 | 100:1 to 1:100 |
| Triarathene | 500:1 to 1:500 | 100:1 to 1:100 |
| Triazamate | 500:1 to 1:500 | 100:1 to 1:100 |
| Triazophos | 500:1 to 1:500 | 100:1 to 1:100 |
| Trichlorfon | 500:1 to 1:500 | 100:1 to 1:100 |
| Trichogramma spp. | | |
| Triflumuron | 500:1 to 1:500 | 100:1 to 1:100 |
| Verticillium lecanii | | |
| Zeta-Cypermethrin | 500:1 to 1:500 | 100:1 to 1:100 |

In particular the mixtures according to the invention are suitable for the treatment of seed also. Thus, most of the damage to crop plants which is caused by pests occurs when the seed itself is infested during storage and after the seed is introduced into the soil, and during and immediately after germination of the plants. This phase is particularly critical since the roots and shoots of the growing plant are particularly sensitive and even minor damage can lead to the death of the whole plant. Protecting the seed and the germinating plant by the use of suitable compositions is therefore of particularly great interest.

The control of pests by treatment of the seed of plants has been known for a long time and is a subject of continual improvements. However, the treatment of seed frequently entails a series of problems which cannot always be solved in a satisfactory manner. Thus, it is desirable to develop methods of protecting the seed and the germinating plant which dispense with the additional application of crop protection products after planting or after emergence of the plants. It is furthermore desirable to optimize the amount of active ingredient employed in such a way as to provide optimum protection for the seed and the germinating plant from attack by pests, but without damaging the plant itself by the active ingredient employed. In particular, methods for the treatment of seed should also take into consideration the intrinsic insecticidal properties of transgenic plants in order to achieve optimum protection of the seed and the germinating plant with a minimum of crop protection products being employed.

The present invention therefore in particular also provides a method of protecting seed and germinating plants from attack by pests, by treating the seed with a composition according to the invention. The invention likewise provides for the use of the compositions according to the invention for the treatment of seed for protecting the seed and the germinating plant from pests. Furthermore, the invention provides seed which has been treated with a composition according to the invention so as to afford protection from pests.

One of the advantages of the present invention is that the particular properties of the compositions according to the invention mean that treatment of the seed with these compositions protects not only the seed itself, but also the resulting plants after emergence, from pests. In this manner, the direct treatment of the crop at the time of sowing or shortly thereafter can be dispensed with.

A further advantage is the synergistically increased insecticidal activity of the compositions according to the invention in comparison with the respective individual active ingredients. This makes possible an optimization of the amount of active ingredient employed. Here, it has to be considered as being particularly advantageous that, by the presence of the cocomponents of group (b), the damage to the emerging plants that may be caused by the insecticidally active ingredients used can, in a surprisingly effective manner, be limited or prevented altogether.

Furthermore, it must be considered as being advantageous that the mixtures according to the invention can also be employed in particular in transgenic seed, the plants arising from this seed being capable of expressing a protein directed against pests. By treating such seed with the compositions according to the invention, certain pests can already be controlled by the expression of the protein—for example, an insecticidal protein—and, surprisingly, the result in addition is a synergistically complemented activity together with the compositions according to the invention, which, again, increases the efficacy of the protection against attack by pests.

The compositions according to the invention are suitable for protecting seed of any plant variety which is employed in agriculture, in the greenhouse, in forests, in horticulture or in viticulture. In particular, this takes the form of seed of corn, peanut, canola, oilseed rape, poppy, olive, coconut, cacao, soybean, cotton, beet (for example, sugar beet and fodder beet), rice, millet, wheat, barley, oats, rye, sunflower, sugarcane or tobacco. The compositions according to the invention are likewise suitable for treating the seed of various vegetable species, such as, for example, broccoli, cauliflower, white cabbage, tomato, bell pepper, melon, zucchini and cucumbers, or various pomaceous fruit, such as, for example, apple or pear. The treatment of the seed of corn, soybean, cotton, wheat and canola or oilseed rape is of particular importance.

As already mentioned above, the treatment of transgenic seed with a composition according to the invention is also of particular importance. This takes the form of seed of plants which, as a rule, comprise at least one heterologous gene which governs the expression of a polypeptide with in particular insecticidal properties. In this context, the heterologous genes in transgenic seed may be derived from microorganisms such as Bacillus, Rhizobium, Pseudomonas, Serratia, Trichoderma, Clavibacter, Glomus or Gliocladium. The present invention is particularly suitable for the treatment of transgenic seed which comprises at least one heterologous gene orignating from Bacillus sp. and whose gene product shows activity against the European corn borer and/or the corn root worm. It is with particular preference a heterologous gene derived from Bacillus thuringiensis.

Within the scope of the present invention, the composition according to the invention is applied to the seed either alone or in suitable formulation. Preferably, the seed is treated in a state in which it is stable enough to avoid damage during treatment. In general, the seed may be treated at any point in time between harvest and sowing. The seed usually used has been separated from the plant and freed from cobs, shells, stalks, coats, hairs or the flesh of the fruits.

When treating the seed, care must generally be taken that the amount of the composition according to the invention applied to the seed and/or the amount of further additives is chosen in such a way that the germination of the seed is not adversely affected, or that the resulting plant is not damaged. This must be borne in mind in particular in the case of active ingredients which may have phytotoxic effects at certain application rates.

The compositions according to the invention can be applied directly, that is to say without comprising further components and without having been diluted. As a rule, it is preferable to apply the compositions to the seed in the form of a suitable formulation. Suitable formulations and methods for the treatment of seed are known to the skilled worker and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

The active ingredients or active ingredient combinations can be converted into the customary formulations, such as solutions, emulsions, wettable powders, suspensions, powders, dusts, pastes, soluble powders, granules, suspoemulsion concentrates, natural and synthetic materials impregnated with active ingredients and microencapsulations in polymeric materials.

These formulations are produced in a known manner: for example, by mixing the active ingredients with extenders, that is, liquid solvents and/or solid carriers, optionally with the use of surface-active agents, that is, emulsifiers and/or dispersants and/or foam formers.

If the extender used is water, it is also possible to use for example organic solvents as auxiliary solvents. Suitable liquid solvents are mainly as follows: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, mineral oil fractions, for example, mineral and vegetable oils, alcohols, such as butanol or glycol and ethers and esters thereof, ketones, such as acetone, methyl ethyl ketone, methyl isobutyl ketone or cyclohexanone, strongly polar solvents, such as dimethylformamide and dimethyl sulfoxide, and water.

Suitable solid carriers are:

for example, ammonium salts and ground natural minerals, such as kaolins, clays, talc, chalk, quartz, attapulgite, montmorillonite or diatomaceous earth, and ground synthetic minerals, such as finely divided silica, alumina and silicates; suitable solid carriers for granules are: for example, crushed and fractionated natural rocks such as calcite, marble, pumice, sepiolite and dolomite, and synthetic granules of inorganic and organic meals, and granules of organic material such as sawdust, coconut shells, maize cobs and tobacco stalks; suitable emulsifiers and/or foam formers are: for example, nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and protein hydrolysates; suitable dispersants are: for example, lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, and natural phospholipids, such as cephalins and lecithins, and synthetic phospholipids can be used in the formulations. Other possible additives are mineral and vegetable oils.

It is possible to use colorants such as inorganic pigments, for example iron oxide, titanium oxide and Prussian Blue, and organic dyes, such as alizarin dyes, azo dyes and metal phthalocyanine dyes, and trace nutrients such as salts of iron, manganese, boron, copper, cobalt, molybdenum and zinc.

The formulations in general comprise between 0.1 and 95% by weight of active ingredients, including the active safener ingredients, preferably between 0.5 and 90%.

The combinations of active ingredients are generally applied in the form of ready-to-use formulations. However, the active ingredients contained in the combinations of active ingredients may also be applied in the form of individual formulations which are mixed upon use, that is, in the form of tank mixes.

The combinations of active ingredients, as such or in their formulations, may furthermore also be used as a mixture with other known herbicides, again with ready-to-use formulations or tank mixes being possible. A mixture with other known active ingredients, such as fungicides, insecticides, acaricides, nematicides, attractants, sterilants, bactericides, bird repellents, growth substances, plant nutrients and soil conditioners, is also possible. It may furthermore be advantageous for specific applications, in particular for post-emergence application, to incorporate into the formulations plant-compatible mineral or vegetable oils (for example, the commercial product “Rako Binol”) or ammonium salts, such as, for example, ammonium sulfate or ammonium thiocyanate, as further additives.

The combinations of active ingredients can be used as such, in the form of their formulations or the use forms which can be prepared from these formulations by further dilution, such as ready-to-use solutions, suspensions, emulsions, powders, pastes and granules. Application is effected in the customary manner, for example by watering, spraying, atomizing, dusting or broadcasting.

The application rates of the combination of active ingredients can be varied within a certain range; they depend, inter alia, on the weather and the soil factors. In general, the application rates are between 0.005 and 5 kg per ha, preferably between 0.01 and 2 kg per ha, more preferably between 0.05 and 1.0 kg per ha.

The combinations of active ingredients can be applied before and after emergence of the plants, i.e. both pre-emergence and post-emergence.

Depending on their properties, the safeners to be used can be employed for pretreating the seed of the crop plant (seed dressing) or can be incorporated into the seed furrows before sowing, or, together with the herbicide, can be applied before or after emergence of the plants.

The combinations of active ingredients are suitable for controlling animals pests, preferably arthropods and nematodes, in particular insects and arachnids, which are encountered in agriculture. They are effective against normally sensitive and resistant species and against all or individual stages of development. The abovementioned pests include:

From the order of the Isopoda, for example, Oniscus asellus, Armadillidium vulgare, Porcellio scaber. From the order of the Diplopoda, for example, Blaniulus guttulatus. From the order of the Chilopoda, for example, Geophilus carpophagus, Scutigera spp. From the order of the Symphyla, for example, Scutigerella immaculata. From the order of the Thysanura, for example, Lepisma saccharina. From the order of the Collembola, for example, Onychiurus armatus. From the order of the Orthoptera, for example, Acheta domesticus, Gryllotalpa spp., Locusta migratoria migratorioides, Melanoplus spp., Schistocerca gregaria. From the order of the Blattaria, for example, Blatta orientalis, Periplaneta americana, Leucophaea maderae, Blattella germanica. From the order of the Dermaptera, for example, Forficula auricularia. From the order of the Isoptera, for example, Reticulitermes spp. From the order of the Phthiraptera, for example, Pediculus humanus corporis, Haematopinus spp., Linognathus spp., Trichodectes spp., Damalinia spp. From the order of the Thysanoptera, for example, Hercinothrips femoralis, Thrips tabaci, Thrips palmi, Frankliniella occidentalis. From the order of the Heteroptera, for example, Eurygaster spp., Dysdercus intermedius, Piesma quadrata, Cimex lectularius, Rhodnius prolixus, Triatoma spp. From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp. From the order of the Lepidoptera, for example, Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae. From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus. From the order of the Hymenoptera, for example, Diprion spp., Hoplocampa spp., Lasius spp., Monomorium pharaonis, Vespa spp. From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp. From the order of the Siphonaptera, for example, Xenopsylla cheopis, Ceratophyllus spp.

From the class of the arachnids, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The phytoparasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

When used as insecticides, the combinations of active ingredients can further be present, in their commercial formulations and in the use forms prepared from these formulations, as a mixture with further synergists. Synergists are compounds which enhance the activity of the active ingredients, without it being necessary for the added synergist to be active itself.

The active ingredient content of the use forms prepared from the commercial formulations may vary within wide ranges. The concentration of active ingredients of the use forms may be from 0.0000001 to 95% by weight of active ingredient, preferably between 0.0001 and 1% by weight.

Application is carried out in a customary manner adapted to the use forms.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by varietal property rights. Parts of plants are to be understood as meaning all above-ground and below-ground parts and organs of plants, such as shoot, leaf, flower and root, examples that may be mentioned being leaves, needles, stems, trunks, flowers, fruit-bodies, fruits and seeds and also roots, tubers and rhizomes. Parts of plants also include harvested plants and vegetative and generative propagation material; for example, seedlings, tubers, rhizomes and cuttings. The combinations according to the invention are in particular also suitable for treating the seed of the crop plants mentioned above.

The treatment of the plants and parts of plants or of the seed according to the invention with the active ingredients is carried out directly or by action on their environment, habitat or storage area according to customary treatment methods, for example by dipping, spraying, evaporating, atomizing, broadcasting, brushing-on and, in the case of propagation material, in particular in the case of seeds, additionally by single- or multi-layer coating.

As already mentioned above, it is possible to treat all plants and their parts according to the invention. In a preferred embodiment, wild plant species and plant varieties, or those obtained by conventional biological breeding methods, such as crossing or protoplast fusion, and parts thereof, are treated. In a further preferred embodiment, transgenic plants and plant varieties obtained by genetic engineering, if appropriate in combination with conventional methods (Genetically Modified Organisms), and parts thereof are treated. The term “parts” or “parts of plants” or “plant parts” has been explained above.

With particular preference, plants of the plant varieties which are in each case commercially available or in use are treated according to the invention.

Depending on the plant species or plant varieties, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant varieties (i.e. those obtained by genetic engineering) which are preferred and to be treated according to the invention include all plants which, in the genetic modification, received genetic material which imparts particularly advantageous useful traits to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defense of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), corn, soybeans, potatoes, cotton, oilseed rape and also fruit plants (with the fruits apples, pears, citrus fruits and grapes), and particular emphasis is given to corn, soybeans, potatoes, cotton and oilseed rape. Traits that are particularly emphasized are the increased defense of the plants against insects by toxins formed in the plants, in particular those formed by the genetic material from Bacillus thuringiensis (for example by the genes CryIA(a), CryIA(b), CryIA(c), CryIA, CryIIA, CrylIIB2, Cry9c Cry2Ab, Cry3Bb and CryIF and also combinations thereof) (hereinbelow referred to as “Bt plants”). Traits that are furthermore particularly emphasized are the increased tolerance of the plants to certain herbicidally active ingredients, for example imidazolinones, sulfonylureas, glyphosate or phosphinotricin (for example the “PAT” gene). The genes which impart the desired traits in question can also be present in combination with one another in the transgenic plants. Examples of “Bt plants” which may be mentioned are corn varieties, cotton varieties, soybean varieties and potato varieties which are sold under the trade names YIELD GARD® (for example corn, cotton, soybeans), KnockOut® (for example corn), StarLink® (for example corn), Boilgard® (cotton), Nucotn® (cotton) and NewLeaf® (potato). Examples of herbicide-tolerant plants which may be mentioned are corn varieties, cotton varieties and soybean varieties which are sold under the trade names Roundup Ready® (tolerance to glyphosate, for example corn, cotton, soybean), Liberty Link® (tolerance to phosphinotricin, for example oilseed rape), IMI® (tolerance to imidazolinones) and STS® (tolerance to sulfonylureas, for example corn). Herbicide-resistant plants (plants bred in a conventional manner for herbicide tolerance) which may be mentioned include the varieties sold under the name Clearfield® (for example, corn). Of course, these statements also apply to plant varieties which have these or still-to-be-developed genetic traits, and which will be developed and/or marketed in the future.

The plants listed and/or their seed can be treated according to the invention in a particularly advantageous manner with the active ingredient mixtures. The preferred ranges stated above for the mixtures also apply to the treatment of these plants and their seed. Particular emphasis is given to the treatment of plants and seed with the mixtures specifically mentioned in the present text.

The expected activity for a given combination of two active ingredients can be calculated (cf. Colby, S. R.; “Calculating Synergistic and Antagonistic Responses of Herbicide Combinations”, Weeds 15, pages 20-22, 1967):

If
x=the kill rate, expressed in % of the untreated control, when employing active ingredient A at an application rate of m ppm,
Y=the kill rate, expressed in % of the untreated control, when employing active ingredient B at an application rate of n ppm, and
E=the kill rate, expressed in % of the untreated control, when employing active ingredients A and B at application rates of m and n ppm,
   then

E=X+Y−(X+Y)/100.

If the actual insecticidal kill rate is higher than the calculated one, the kill of the combination is superadditive, i.e. a synergistic effect is present. In this case, the kill rate that is actually observed has to be higher than the value, calculated using the formula above, for the expected kill rate (E).

On the basis of the following examples, which should not be interpreted as limiting, a synergistically boosted activity is demonstrated in comparison to the components employed individually.

### EXAMPLES

Spray tratment - runoff

| | |
|---|---|
| Solvent: | water |
| Adjuvant: | 0.1% rapeseed oil methyl ester |

An appropriate solution is prepared by mixing 1 part by weight of formulation with the stated amount of water and adjuvant, and diluting the concentrate with water to the desired concentration.

a) Heliothis armigera Test

Cotton plants (Gossypium hirsutum) are sprayed to runoff with the desired use concentration and are populated with caterpillars of the cotton boll worm (Heliothis armigera) while the leaves are still wet. See table A.

b) Spodoptera frugiperda Test

Corn plants (Zea mais) are sprayed to runoff with the desired use concentration and are populated with caterpillars of the army worm (Spodoptera frugiperda) while the leaves are still wet.

c) Plutella xylostella Test

Cabbage plants (Brassica pekinesis) are sprayed to runoff with the desired use concentration and are populated with larvae of the cabbage moth (Plutella xylostella) while the leaves are still wet.

d) Aphis gossypii Test

Cotton plants (Gossypium herbaceum) heavily infested by the cotton aphid (Aphis gossypii) are sprayed to runoff with the desired concentration of the application solution.

e) Myzus persicae Test

Bell pepper plants (Capsicum sativum) heavily infested by the green peach aphid (Myzus persicae) are sprayed to runoff with the desired concentration of the application solution.

After the desired time the kill in % is determined in each case. In this context, 100% means that all of the larvae have been killed; 0% means that no larvae have been killed. The kill figures determined are calculated in accordance with the Colby formula described above.

TABLE A
Heliothis armigera test

| | Concentration | Kill | |
|---|---|---|---|
| Active ingredient/formulation | in ppm | in % after 3^{d} | |
| Chlorpyrifos | 4 | 0 | |
| Isoxadifen-ethyl WG 50 | 100 | 0 | |
| | | found* | calc.** |
| Chlorpyrifos + Isoxadifen-ethyl | 4 + 100 | 66 | 0 |
| (1:25) | | | |

*found = effect found
**calc. = effect calculated by the Colby formula

TABLE B
Plutella xylostella test

| | Concentration | Kill | |
|---|---|---|---|
| Active ingredient/formulation | in ppm | in % after 7^{d} | |
| Chlorpyrifos | 4 | 0 | |
| Isoxadifen-ethyl WG 50 | 100 | 0 | |
| | | found* | calc.** |
| Chlorpyrifos + isoxadifen-ethyl | 4 + 100 | 30 | 0 |
| (1:25) | | | |
| Fenclorim | 100 | 0 | |
| | | found* | calc.** |
| Chlorpyrifos + fenclorim (1:25) | 4 + 100 | 50 | 0 |
| Methiocarb | 20 | 0 | |
| | | found* | calc.** |
| Methiocarb + isoxadifen-ethyl | 20 + 100 | 30 | 0 |
| (1:5) | | | |

*found = effect found
**calc. = effect calculated by the Colby formula

TABLE C1
Spodoptera frugiperda test

| | Concentration | Kill | |
|---|---|---|---|
| Active ingredient/formulation | in ppm | in % after 3^{d} | |
| Chlorpyrifos | 4 | 50 | |
| AE 1789 a.i. | 50 | 0 | |
| | | found* | calc.** |
| Chlorpyrifos + AE 1789 (1:12.5) | 4 + 50 | 66 | 50 |
| Cloquintocet-mexyl WP 20 | 50 | 0 | |
| | | found* | calc.** |
| Chlorpyrifos + cloquintocet- | 4 + 50 | 83 | 50 |
| mexyl (1:12.5) | | | |

*found = effect found
**calc. = effect calculated by the Colby formula

TABLE C2
Spodoptera frugiperda test

| | Concentration | Kill | |
|---|---|---|---|
| Active ingredient/formulation | in ppm | in % after 3^{d} | |
| Methiocarb | 20 | 17 | |
| Isoxadifen-ethyl WG 50 | 50 | 0 | |
| | | found* | calc.** |
| Methiocarb + isoxadifen-ethyl | 20 + 50 | 50 | 17 |
| (1:2.5) | | | |
| Mefenpyr WG 15 | 100 | 0 | |
| | | found* | calc.** |
| Methiocarb + mefenpyr (1:5) | 20 + 100 | 100 | 17 |
| AE 1789 a.i. | 100 | 0 | |
| | | found* | calc.** |
| Methiocarb + AE 1789 (1:5) | 20 + 100 | 66 | 17 |
| Cloquintocet-mexyl WP 20 | 100 | 0 | |
| | | found* | calc.** |
| Methiocarb + cloquintocet- | 20 + 100 | 50 | 17 |
| mexyl (1:5) | | | |
| Dichlormid a.i. | 50 | 0 | |
| | | found* | calc.** |
| Methiocarb + dichlormid (1:2.5) | 20 + 50 | 66 | 17 |
| Fenclorim a.i. | 100 | 0 | |
| | | found* | calc.** |
| Methiocarb + fenclorim (1:5) | 20 + 100 | 50 | 17 |
| Furilazole a.i. | 100 | 0 | |
| | | found* | calc.** |
| Methiocarb + furilazole (1:5) | 20 + 100 | 83 | 17 |

*found = effect found
**calc. = effect calculated by the Colby formula

TABLE D1
Aphis gossypii test

| | Concentration | Kill | |
|---|---|---|---|
| Active ingredient/formulation | in ppm | in % after 3^{d} | |
| β-Cyfluthrin | 0.8 | 35 | |
| Isoxadifen-ethyl WG 50 | 100 | 0 | |
| | | found* | calc.** |
| β-Cyfluthrin + isoxadifen- | 0.8 + 100 | 70 | 35 |
| ethyl (1:125) | | | |
| Mefenpyr WG 15 | 50 | 0 | |
| | | found* | calc.** |
| β-Cyfluthrin + mefenpyr | 0.8 + 50 | 55 | 35 |
| (1:61.5) | | | |
| AE 1789 a.i. | 100 | 0 | |
| | | found* | calc.** |
| β-Cyfluthrin + AE 1789 | 0.8 + 100 | 55 | 35 |
| (1:125) | | | |
| Cloquintocet-mexyl WP 20 | 100 | 0 | |
| | | found* | calc.** |
| β-Cyfluthrin + cloquintocet- | 0.8 + 100 | 75 | 35 |
| mexyl (1:125) | | | |
| Dichlormid a.i. | 100 | 0 | |
| | | found* | calc.** |
| β-Cyfluthrin + dichlormid | 0.8 + 100 | 65 | 35 |
| (1:125) | | | |
| Fenclorim a.i. | 100 | 0 | |
| | | found* | calc.** |
| β-Cyfluthrin + fenclorim (1:125) | 0.8 + 100 | 65 | 35 |
| Furilazole a.i. | 100 | 0 | |
| | | found* | calc.** |
| β-Cyfluthrin + furilazole (1:125) | 0.8 + 100 | 65 | 35 |

*found = effect found
**calc. = effect calculated by the Colby formula

TABLE D2
Aphis gossypii test

| | Concentration | Kill | |
|---|---|---|---|
| Active ingredient/formulation | in ppm | in % after 3^{d} | |
| Deltamethrin | 0.8 | 15 | |
| Isoxadifen-ethyl WG 50 | 100 | 0 | |
| | | found* | calc.** |
| Deltamethrin + isoxadifen-ethyl | 0.8 + 100 | 45 | 15 |
| (1:125) | | | |
| Mefenpyr WG 15 | 100 | 0 | |
| | | found* | calc.** |
| Deltamethrin + mefenpyr | 0.8 + 100 | 65 | 15 |
| (1:125) | | | |
| AE 1789 a.i. | 100 | 0 | |
| | | found* | calc.** |
| Deltamethrin + AE 1789 (1:125) | 0.8 + 100 | 65 | 15 |
| Cloquintocet-mexyl WP 20 | 100 | 0 | |
| | | found* | calc.** |
| Deltamethrin + cloquintocet- | 0.8 + 100 | 50 | 15 |
| mexyl (1:125) | | | |
| Fenclorim a.i. | 100 | 0 | |
| | | found* | calc.** |
| Deltamethrin + fenclorim | 0.8 + 100 | 35 | 15 |
| (1:125) | | | |
| Furilazole a.i. | 100 | 0 | |
| | | found* | calc.** |
| Deltamethrin + furilazole | 0.8 + 100 | 70 | 15 |
| (1:125) | | | |

*found = effect found
**calc. = effect calculated by the Colby formula

TABLE E1
Myzus persicae test

| | Concentration | Kill | |
|---|---|---|---|
| Active ingredient/formulation | in ppm | in % after 3^{d} | |
| β-Cyfluthrin | 0.8 | 10 | |
| Isoxadifen-ethyl WG 50 | 100 | 0 | |
| | | found* | calc.** |
| β-Cyfluthrin + isoxadifen-ethyl | 0.8 + 100 | 40 | 10 |
| (1:125) | | | |

TABELLE E2
Myzus persicae test

| | Concentration | Kill | |
|---|---|---|---|
| Active ingredient/formulation | in ppm | in % after 1^{d} | |
| Deltamethrin | 0.8 | 20 | |
| Isoxadifen-ethyl WG 50 | 100 | 0 | |
| | | found* | calc.** |
| Deltamethrin + isoxadifen-ethyl | 0.8 + 100 | 60 | 20 |
| (1:125) | | | |
| Mefenpyr WG 15 | 100 | 0 | |
| | | found* | calc.** |
| Deltamethrin + mefenpyr | 0.8 + 100 | 45 | 20 |
| (1:125) | | | |
| AE 1789 a.i. | 100 | 0 | |
| | | found* | calc.** |
| Deltamethrin + AE 1789 (1:125) | 0.8 + 100 | 65 | 20 |
| Furilazole a.i. | 100 | 0 | |
| | | found* | calc.** |
| Deltamethrin + furilazole | 0.8 + 100 | 40 | 20 |
| (1:125) | | | |

*found = effect found
**calc. = effect calculated by the Colby formula

1. A composition comprising an effective amount of an active ingredient combination comprising at least one ingredient selected from the group comprising:
(A) acetylcholinesterase inhibitor
from the series azinphos-methyl, chlorpyrifos, diazinon, dimethoate, disulfoton, ethion, fenitrothion, fenthion, isoxathion, malathion, methidathion, oxydemeton-methyl, parathion, parathion-methyl, phenthoate, phorate, phosalone, phosmet, phoxim, pirimiphos-methyl, profenofos, prothiofos, tebupirimfos, triazophos, chlorfenvinphos, dichlorphos, dicrotophos, mevinphos, monocrotophos, phosphamidon, acephate, methamidophos, trichlorfon, carbaryl, formetanate, formetanate hydrochloride, methiocarb, methomyl, oxamyl, pirimicarb, propoxur, thiodicarb, or a mixture thereof;
(B) sodium channel modulator
from the series acrinathrin, alpha-cypermethrin, beta-cyfluthrin, cyhalothrin, cypermethrin, deltamethrin, esfenvalerate, etofenprox, fenpropathrin, fenvalerate, flucythrinate, lambda-cyhalothrin, permethrin, tau-fluvalinate, tralomethrin, zeta-cypermethrin, indoxacarb, bifenthrin, or a mixture thereof,
(C) chitin biosynthesis inhibitor
from the series chlorfluazuron, diflubenzuron, lufenuron, teflubenzuron, triflumuron, cyromazine, or a mixture thereof;
(D) juvenile hormone mimetics
from the series fenoxycarb, diofenolan, pyriproxyfen;
(E) chloride channel activator
from the series abamectin, ivermectin, emamectin, milbemectin, or a mixture thereof;
(F) ecdysone agonist/disruptor
from the series methoxyfenozide, tebufenozide, or a mixture thereof;
(G) GABA-controlled chloride channel antagonist
from the series endosulfan, gamma-HCH, fipronil, or a mixture thereof;
(H) acaricide
from the series fenazaquin, tebufenpyrad, pyrimidifen, dicofol, triarathene, tetradifon, propargite, hexythiazox, bromopropylate, 2-(acetyloxy)-3-dodecyl-1,4-naphthalenedione, or a mixture thereof; and
(I) compounds or biologicals
from the series amitraz, pymetrozine, azadirachtin, Trichogramma spp., Verticiliium lecanii, buprofezin, chinomethionat, thiocyclam hydrogen oxalate, triazamate, thuringiensin, chlorfenapyr, diafenthiuron, spinosad, or a mixture thereof;
and wherein said composition further comprises
at least one crop plant tolerance promoter compound from the following group of compounds:
4-dichloroacetyl-1-oxa-4-azaspiro[4.5]decane (AD-67, MON-4660), 1-dichloroacetylhexahydro-3,3,8a-trimethylpyrrolo[1,2-a]pyrimidin-6(2H)-one (dicyclonon, BAS-145138), 4-dichloroacetyl-3,4-dihydro-3-methyl-2H-1,4-benzoxazine (benoxacor), 1-methylhexyl 5-chloroquinoline-8-oxyacetate (cloquintocet-mexyl—cf. also related compounds in EP-A-86750, EP-A-94349, EP-A-191736, EP-A-492366), 3-(2-chlorobenzyl)-1-(1-methyl-1-phenylethyl)urea (cumyluron), α-(cyanomethoximino)phenylacetonitrile (cyometrinil), 2,4-dichlorophenoxyacetic acid (2,4-D), 4-(2,4-dichlorophenoxy)butyric acid (2,4-DB), 1-(1-methyl-1-phenylethyl)-3-(4-methylphenyl)urea (daimuron, dymron), 3,6-dichloro-2-methoxybenzoic acid (dicamba), S-1-methyl-1-phenylethyl piperidine-1-thiocarboxylate (dimepiperate), 2,2-dichloro-N-(2-oxo-2-(2-propenylamino)ethyl)-N-(2-propenyl)acetamide (DKA-24), 2,2-dichloro-N,N-di-2-propenylacetamide (dichlormid), 4,6-dichloro-2-phenylpyrimidine (fenclorim), ethyl 1-(2,4-dichlorophenyl)-5-trichloromethyl-1H-1,2,4-triazole-3-carboxylate (fenchlorazole-ethyl—cf. also related compounds in EP-A-174562 and EP-A-346620), phenylmethyl 2-chloro-4-trifluoromethylthiazole-5-carboxylate (flurazole), 4-chloro-N-(1,3-dioxolan-2-ylmethoxy)-α-trifluoroacetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl—cf. also related compounds in WO-A-95/07897), 1-(ethoxycarbonyl)ethyl 3,6-dichloro-2-methoxybenzoate (lactidichlor), (4-chloro-o-tolyloxy)acetic acid (MCPA), 2-(4-chloro-o-tolyloxy)propionic acid (mecoprop), diethyl 1-(2,4-dichorophenyl)-4,5-dihydro-5-methyl-1H-pyrazole-3,5-dicarboxylate (mefenpyr-diethyl—cf. also related compounds in WO-A-91/07874), 2-dichloromethyl-2-methyl-1,3-dioxolane (MG-191), 2-propenyl-1-oxa-4-azaspiro[4.5]decane-4-carbodithioate (MG-838), 1,8-naphthalic anhydride, α-(1,3-dioxolan-2-ylmethoximino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-29148), 4-(4-chloro-o-tolyl)butyric acid, 4-(4-chlorophenoxy)butyric acid, diphenylmethoxyacetic acid, methyl diphenylmethoxyacetate, ethyl diphenylmethoxyacetate, methyl 1-(2-chlorophenyl)-5-phenyl-1H-pyrazole-3-carboxylate, ethyl 1-(2,4-dichlorophenyl)-5-methyl-1H-pyrazole-3-carboxylate, ethyl 1-(2,4-dichlorophenyl)-5-isopropyl-1H-pyrazole-3-carboxylate, ethyl 1-(2,4-dichlorophenyl)-5-(1,1-dimethylethyl)-1H-pyrazole-3-carboxylate, ethyl 1-(2,4-dichlorophenyl)-5-phenyl-1H-pyrazole-3-carboxylate (cf. also related compounds in EP-A-269806 and EP-A-333131), ethyl 5-(2,4-dichlorobenzyl)-2-isoxazoline-3-carboxylate, ethyl 5-phenyl-2-isoxazoline-3-carboxylate, ethyl 5-(4-fluorophenyl)-5-phenyl-2-isoxazoline-3-carboxylate (cf also related compounds in WO-A-91/08202), 1,3-dimethylbut-1-yl 5-chloroquinoline-8-oxyacetate, 4-allyloxybutyl 5-chloroquinoline-8-oxyacetate, 1-allyloxyprop-2-yl 5-chloroquinoline-8-oxyacetate, methyl 5-chloroquinoxaline-8-oxyacetate, ethyl 5-chloroquinoline-8-oxyacetate, allyl 5-chloroquinoxaline-8-oxyacetate, 2-oxoprop-1-yl 5-chloroquinoline-8-oxyacetate, diethyl 5-chloroquinoline-8-oxymalonate, diallyl 5-chloroquinoxaline-8-oxymalonate, diethyl 5-chloroquinoline-8-oxymalonate (cf. also related compounds in EP-A-582198), 4-carboxychroman-4-ylacetic acid (AC-304415, cf. EP-A-613618), 4-chlorophenoxyacetic acid, 3,3′-dimethyl-4-methoxybenzophenone, 1-bromo-4-chloromethylsulfonylbenzene, 1-[4-(N-2-methoxybenzoylsulfamoyl)phenyl]-3-methylurea (also known as N-(2-methoxybenzoyl)-4-[(methylaminocarbonyl)-amino]benzenesulfonamide), 1-[4-(N-2-methoxybenzoylsulfamoyl)phenyl]-3,3-dimethylurea, 1-[4-(N-4,5-dimethylbenzoylsulfamoyl)phenyl]-3-methylurea, 1-[4-(N-naphthylsulfamoyl)phenyl]-3,3-dimethylurea, N-(2-methoxy-5-methylbenzoyl)-4-(cyclopropylaminocarbonyl)benzenesulfonamide,
one of the following compounds, defined by general formulae, of the general formula (IIa) 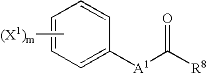
or of the general formula (IIb) 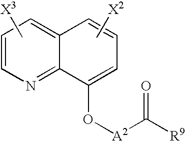
or of the formula (IIc) 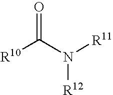
where
m represents a number between 0 and 5,
A¹ represents one of the divalent heterocyclic groupings shown below, 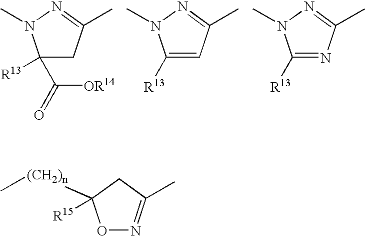
n represents a number between 0 and 5,
A² represents optionally C₁-C₄-alkyl, C₁-C₄-alkoxy-carbonyl- and or C₁-C₄-alkenyloxy-carbonyl-substituted alkanediyl having 1 or 2 carbon atoms,
R⁸ represents hydroxyl, mercapto, amino, C₁-C₆-alkoxy, C₁-C₆-alkylthio, C₁-C₆-alkylamino or di(C₁-C₄-alkyl)amino,
R⁹ represents hydroxyl, mercapto, amino, C₁-C₇-alkoxy, C₁-C₆-alkenyloxy, C₁-C₆-alkenyloxy-C₁-C₆-alkoxy, C₁-C₆-alkylthio, C₁-C₆-alkylamino or di(C₁-C₄-alkyl)amino,
R¹⁰ represents in each case optionally fluorine-, chlorine- and/or bromine-substituted C₁-C₄-alkyl,
R¹¹ represents hydrogen, in each case optionally fluorine-, chlorine- and/or bromine-substituted C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, or optionally fluorine-, chlorine- and/or bromine- or C₁-C₄-alkyl-substituted phenyl,
R¹² represents hydrogen, in each case optionally fluorine-, chlorine- and/or bromine-substituted C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, or optionally fluorine-, chlorine- and/or bromine- or C₁-C₄-alkyl-substituted phenyl, and R¹¹ and R¹² also together represent C₃-C₆-alkanediyl or C₂-C₅-oxaalkanediyl in each case optionally substituted by C₁-C₄-alkyl, phenyl, furyl, a fused benzene ring or by two substituents which, together with the C atom to which they are attached, form a 5- or 6-membered carboxycle,
R¹³ represents hydrogen, cyano, halogen, or represents in each case optionally fluorine-, chlorine- and/or bromine-substituted C₁-C₄-alkyl, C₃-C₆-cycloalkyl or phenyl,
R¹⁴ represents hydrogen, optionally hydroxyl-, cyano-, halogen- or C₁-C₄-alkoxy-substituted C₁-C₆-alkyl, C₃-C₆-cycloalkyl or tri(C₁-C₄-alkyl)silyl,
R¹⁵ represents hydrogen, cyano, halogen, or represents in each case optionally fluorine-, chlorine- and/or bromine-substituted C₁-C₄-alkyl, C₃-C₆-cycloalkyl or phenyl,
X¹ represents nitro, cyano, halogen, C₁-C₄-alkyl, C₁-C₄-haloalkyl, C₁-C₄-alkoxy or C₁-C₄-haloalkoxy,
X² represents hydrogen, cyano, nitro, halogen, C₁-C₄-alkyl, C₁-C₄-haloalkyl, C₁-C₄-alkoxy or C₁-C₄-haloalkoxy,
X³ represents hydrogen, cyano, nitro, halogen, C₁-C₄-alkyl, C₁-C₄-haloalkyl, C₁-C₄-alkoxy or C₁-C₄-haloalkoxy,
and/or the following compounds, defined by general formulae, of the general formula (IId) 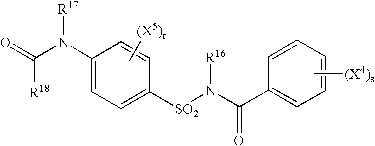
or of the general formula (IIe) 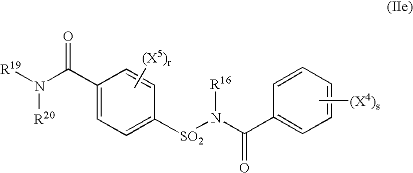
where
r and s represent a number between 0 and 5,
R¹⁶ represents hydrogen or C₁-C₄-alkyl,
R¹⁷ represents hydrogen or C₁-C₄-alkyl,
R¹⁸ represents hydrogen, in each case optionally cyano-, halogen- or C₁-C₄-alkoxy-substituted C₁-C₆-alkyl, C₁-C₆-alkoxy, C₁-C₆-alkylthio, C₁-C₆-alkylamino or di(C₁-C₄-alkyl)amino, or in each case optionally cyano-, halogen- or C₁-C₄-alkyl-substituted C₃-C₆-cycloalkyl, C₃-C₆-cycloalkyloxy, C₃-C₆-cycloalkylthio or C₃-C₆-cycloalkylamino,
R¹⁹ represents hydrogen, optionally cyano-, hydroxyl-, halogen- or C₁-C₄-alkoxy-substituted C₁-C₆-alkyl, in each case optionally cyano- or halogen-substituted C₃-C₆-alkenyl or C₃-C₆-alkynyl, or optionally cyano-, halogen- or C₁-C₄-alkyl-substituted C₃-C₆-cycloalkyl,
R²⁰ represents hydrogen, optionally cyano-, hydroxyl-, halogen- or C₁-C₄-alkoxy-substituted C₁-C₆-alkyl, in each case optionally cyano- or halogen-substituted C₃-C₆-alkenyl or C₃-C₆-alkynyl, optionally cyano-, halogen- or C₁-C₄-alkyl-substituted C₃-C₆-cycloalkyl, or optionally nitro-, cyano-, halogen-, C₁-C₄-alkyl-, C₁-C₄-haloalkyl-, C₁-C₄-alkoxy- or C₁-C₄-haloalkoxy-substituted phenyl, or together with R¹⁹ represents in each case optionally C₁-C₄-alkyl-substituted C₂-C₆-alkanediyl or C₂-C₅-oxaalkanediyl,
X⁴ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy or C₁-C₄-haloalkoxy, and
X⁵ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy or C₁-C₄-haloalkoxy.

2. The composition of claim 1, comprising at least one crop plant tolerance promoter compound selected from the group consisting of cloquintocet-mexyl, fenchlorazole-ethyl, isoxadifen-ethyl, mefenpyr-diethyl, furilazole, fenclorim, cumyluron, dymron, dimepiperate, compounds IIe-5, and compound IIe-11.

3. (canceled)

4. A method of controlling arthropods, comprising contacting a composition of claim 1 with the arthropods and/or their habitat.

5. (canceled)

6. A method of protecting seed against arthropods, characterized in that the seed is treated with a composition of claim 1.

7. A seed characterized in that it has been treated with the composition of claim 1.
